(19) United States
(12) Patent Application Publication
(10) Pub. No.: US 2023/0416085 A1
(43) Pub. Date: Dec. 28, 2023

(54) A PROCESS FOR PRODUCING A HYDROGEN-COMPRISING PRODUCT GAS FROM A HYDROCARBON

(71) Applicant: TECHNIP ENERGIES FRANCE, Nanterre Cedex (FR)

(72) Inventors: Jan-Jaap Riegman, Zoetermeer (NL); Antonio Farace, Zoetermeer (NL); Roland Van Uffelen, Zoetermeer (NL); Stéphane Walspurger, Zoetermeer (NL); Matthew Bowers Pitcher, Zoetermeer (NL)

(21) Appl. No.: 18/036,775

(22) PCT Filed: Aug. 12, 2021
(86) PCT No.: PCT/EP2021/072521

§ 371 Date: May 12, 2023

(30) Foreign Application Priority Data
Nov. 13, 2020 (EP) 20207616.2

(51) Int. Cl. C01B 3/48; B01D 53/047; C01B 3/56; C01B 3/50; B01J 19/24; B01J 19/00; B01J 12/00

(52) U.S. Cl. CPC C01B 3/48; B01J 2208/00176; C01B 3/56; C01B 3/501; B01J 19/245; B01J 19/0013; B01J 12/007; C01B 2203/0233; C01B 2203/0238; C01B 2203/0283; C01B 2203/0833; C01B 2203/0822; C01B 2203/0894; C01B 2203/127; C01B 2203/1241; C01B 2203/141; C01B 2203/042; C01B 2203/0405; C01B 2203/0475; B01D 2257/504; B01D 2256/16; C01P 2006/80; B01J 2208/00504; B01D 53/047

(57) ABSTRACT

The invention relates to a hydrogen plant for producing a hydrogen-comprising gas product comprising—a reformer system comprising at least one heat-recuperating reformer reaction unit (5) or a reformer system comprising two or more reformer units (5,22) in parallel, wherein at least one of said parallel reformer units (5) is present in the radiant section (12) of the reformer system, and at least one reformer unit (22) is located outside the radiant section (12) of the reformer system; —a unit (8) configured to obtain hydrogen product gas; —a carbon dioxide capture unit; the hydrogen plant further comprising a passage way configured to feed a hydrogen-comprising gas stream to the radiant section. The invention further relates to a process for producing a hydrogen-comprising gas product.

The invention relates to a process for producing product gas comprising hydrogen from a hydrocarbon. The invention further relates to a hydrogen plant, suitable for carrying out such a method.

Plants for producing hydrogen from hydrocarbons, in particular steam methane reforming (SMR) plants, are widely applied in refinery complexes to supply hydrogen for upgrading of several products, for example in hydrocracking, hydrogenation or hydrodesulphurization. Additionally, hydrogen is used as a component of syngas (a mixture comprising hydrogen and carbon monoxide). Syngas is an essential building block to produce ammonia, methanol and synthetic fuels. Furthermore there is growing interest in using hydrogen as such as an alternative to petroleum-based fuel in energy sector as a means to provide seasonal energy storage, in industry to provide high quality heat and in mobility mostly for heavy and long hauls transportation means. It is estimated that about 95% of the global hydrogen supply is produced from fossil fuels; as by-product of the technology, CO₂ is produced and emitted to the atmosphere. The CO₂ is produced not only by combustion of a carbon-based fuel for heating the feedstock to the temperatures needed to carry out the reforming, but CO₂ is also formed as a side-product in the hydrogen production: the steam reforming reaction produces carbon monoxide (with methane as a starting compound: CH₄+H₂O [symbol] CO+3H₂), which is subsequently converted to carbon dioxide via the water gas shift reaction (CO+H₂O [symbol] CO₂+H₂). The steam reforming reaction is highly endothermic and requires a significant additional heat input which is traditionally supplied by combustion of waste gasses from the hydrogen production and a hydrocarbon make-up fuel. The endothermal character of steam reforming, but also of dry-reforming (a process wherein use is made of CO₂ instead of steam as a further reformer reaction) makes these processes highly distinct from exothermal reforming, also known as autothermal reforming (ATR) or partial oxidation reforming. As the skilled person will understand, exothermal reforming processes are carried out without needing a significant heat input for the required heat of reaction, such as heat generated in a radiant section of a fired reformer system.

In recent years an increasing industrial focus on the environmental emissions and reduction of the carbon footprint challenges the design of hydrogen production facilities (a.k.a. Hydrogen Production Units: HPU's) to reduce carbon footprint as well.

FIG. 1 schematically shows a typical conventional HPU flow scheme as traditionally applied. An example of a conventional process is described in Industrial Gases in Petrochemical industry by Harold Gunardson, 1997, (page 59). In the scheme shown in FIG. 1, a hydrocarbon feed (1), usually natural gas, LPG, naphtha or refinery off-gas, which may be mixed with a hydrogen make-up (2), is sent to a hydrodesulphurization section (3) to remove impurities in the feed. The treated feedstock is mixed with steam (4) and preheated before sending the feed/steam mixture to the reformer system, typically comprising a reformer reaction unit (5), formed of a plurality of reformer tubes, positioned in a radiant section (12) wherein it is heated by the heat produced by combusting fuel, usually to a temperature of 800-950° C. Typically the reformer tubes contain a reformer catalyst, in particular a nickel (metallic or oxide) catalyst, preferably on alumina or another support. In the reformer tubes, the hydrocarbon feed is converted into a syngas mixture of H₂, CO, CO₂, H₂O and—usually—CH₄; CH₄ in the syngas mixture leaving the reformer (reformate) can be residual methane, present in the feedstock. The hot reformate is cooled down in a waste heat boiler (6) (producing high pressure steam) before optionally treating it in a shift reactor zone (7), comprising one or more shift reactors, to convert the mixture towards more hydrogen production, making use of the water gas shift reaction. This syngas mixture leaving the shift reactor zone is further cooled down (e.g. to approximately 40° C.) before hydrogen is separated from the syngas mixture (unit 8), to provide the hydrogen product (9), which essentially consists of hydrogen or at least comprises hydrogen as the major component, and a waste gas having a reduced hydrogen content, which is purged. Part of the hydrogen product may be recycled to the feed as make-up hydrogen (2). The waste gas, usually comprises hydrogen, carbon dioxide, carbon monoxide, hydrocarbon (methane) and nitrogen. Exact contents depend on the recovery technique, selected operating conditions and feedstocks; as a typical example for hydrogen recovery by pressure swing adsorption, the following composition is given for the waste gas (tail gas): N₂: about 0.6 vol %, H₂: about 28.5 vol %, CO: about 14.4 vol %, CO₂: about 49.0 vol %, CH₄: about 6.6 vol %. The tail gas is typically applied as a major fuel source to supply the heat required in the reformer (10). An additional external make-up fuel (11) is also added to supply the additionally fired duty that is required. The hot combustion gasses leave the radiant section (12) and are introduced into the convection section (13), where heat is recovered from the flue gases. The hot gasses available heat is used for feed preheating and preheating combustion air. Any residual heat from the flue gas is recovered by steam generation (14). Typically a HPU produces more steam than required for the process and the steam produced in excess is exported (15).

Traditionally, hydrogen plants were integrated with a refinery or industrial complex where the generated excess steam could be used, since the hydrogen plant is considered as an efficient steam producer, in order to recover as much low grade heat as possible, the excess steam generated was optimized to meet the external steam demand, making the excess steam a valuable by-product of the facility. Consequently, the firing and thus CO₂ emissions were not the main design parameters but this changes with the evolving regulations on greenhouse gas emissions. Many different solutions have been proposed to reduce the steam production of the hydrogen plant by reducing the firing in the reformer. The options include preheating the combustion air (up to typically 600° C.) with flue gas or another indirect heat source, preheating fuel and/or tail gas, applying an adiabatic (pre)reforming step. All these solutions reduce the required firing in the reformer and thereby thus also the export steam flowrate and CO₂ emission. However, the majority of the CO₂ emitted through the flue gas comes from the tail gas comprising methane, and further residual hydrogen, carbon monoxide and carbon dioxide produced as part of the reforming reaction.

In recent years, with more focus on CO₂ emissions, a commonly applied solution is to capture CO₂ from the syngas, downstream of the (final) shift reactor. Hydrogen product that is this obtained is generally referred to as blue hydrogen. The total reduction of CO₂ emissions is limited by the CH₄ and CO slip from the reformer system and shift section, respectively, on the process side and the amount of additional fossil fuel fed as make-up fuel to meet the heat duty requirement of the reforming process. The methane slip may be reduced by operating at high reformer outlet temperature, which requires more firing.

EP-A 1 648 817 is an example of a reforming process wherein hydrogen product gas is made from methane and CO₂ from the reformate is captured. In this process, the reformer is operated under conditions wherein a reformate is obtained that is essentially free from hydrocarbons. The reformate is subjected to a further reaction whereby essentially all carbon monoxide is converted to CO₂. The CO₂ is removed from the resultant converted gas flow by gas washing, and the washed hydrogen-rich gas flow is subsequently divided in a pressure-swing adsorption system into a product gas flow made of hydrogen and a waste gas flow (tail gas). The waste gas flow is mixed with hydrogen-rich gas, branched of from the gas flow obtained by gas washing, into a reformer which is essentially a carbon-free combustible gas, and is combusted there.

US 2010/0098601 relates to an another arrangement with a reformer, a shift section and a gas scrubber to recover producing CO₂ product.

US 2008/0155984 relates to a steam reforming system for a combined cycle plant with partial CO₂ capture.

US 2010/158776 and U.S. Pat. No. 7,037,485 relate to a steam reforming system without a recuperative reforming unit and without a parallel non-fired reformer unit. Heat is not directly recovered from the reformate to provide reaction heat for the reforming reaction. Instead, flue gasses are used to pre-heat the hydrocarbon feed prior to entering the reformer unit by convection. The extent of heating that can be achieved without causing unacceptable carbon depositions is a serious limitation. US 2014/0023975 describes a scheme to enable carbon capture from a conventional steam methane reformer by applying a solid electrolyte oxygen separator and combusting the feed in the SMR furnace to produce flue gas. The CO₂ is captured from the flue gas.

U.S. Pat. No. 8,187,363 relates to a method of improving the thermodynamic efficiency of a hydrogen generation system by heating the PSA tail gas stream by indirect heat exchange with a heat source. The heated tail gas is introduced in the combustion zone to reduce the firing in the reformer and thus the CO₂ emissions.

U.S. Pat. No. 8,137,422 relates to a process for producing a hydrogen-containing product gas with reduced carbon dioxide emissions compared to conventional hydrogen production processes. A hydrocarbon and steam are reformed in a reformer and the resulting reformate stream is shifted in one or more shift reactors. The shifted mixture is scrubbed to remove carbon dioxide to form a carbon dioxide-depleted stream. The carbon dioxide-depleted stream is separated to form a hydrogen-containing product gas and a by-product gas. A portion of the hydrogen containing product gas is used as a fuel in the reformer and a portion of the by-product gas is recycled back into the process.

U.S. Pat. No. 9,481,573 relates to a steam reformer unit design, a hydrogen PSA unit design (low recovery), a hydrogen/nitrogen enrichment unit design, and a processing scheme application. These aim to allow re-allocating most of the total hydrogen plant CO₂ emissions load to high pressure syngas stream exiting the water gas shift reactor while minimizing the CO₂ emissions load from the reformer furnace flue gas. The low recovery PSA allows for adjusting the tail gas energy content to the firing duty requirements. The tail gas of the low recovery PSA is the only gas stream fed to the burners.

WO 2017/190066 describes a method for carbon dioxide capturing from a steam methane reformer applying a CO₂ pump comprising an anode and cathode, where the cathode is configured to output a first exhaust stream, comprising oxygen and carbon dioxide, and the anode is configured to receive a reformed gas from the SMR and to output a second exhaust stream consisting of >95% hydrogen.

U.S. Pat. No. 8,790,617 relates to a process for producing hydrogen with complete capture of CO₂ and recycling unconverted methane. A hydrocarbon feed and steam are applied to produce synthesis gas in a reformer, where fuel is applied to supply the required heat. The raw synthesis gas is treated to produce a hydrogen stream with CO₂ and (unconverted) CH₄. The CO₂ is removed from the hydrogen rich stream. The CO₂ depleted stream is treated in an adsorption unit to remove the impurities in the hydrogen rich stream and the impurities are recycled back to the steam reforming step.

US 2017/0002281 relates to a method to produce synthesis gas from hydrocarbons by means of an autothermal, adiabatic or endothermic reforming stage of a recycle of synthesis gas from Fischer Tropsch synthesis.

EP 1977993 relates to a catalytic steam reforming process with a recycle. The sulfur depleted feedstock passes a multitubular catalytic reformer, while externally combusting fuel to supply the energy for the reforming reaction. The steam containing syngas product passes a boiler and part of the gas is recycled to the reformer.

U.S. Pat. No. 9,776,861 relates to a method for steam reforming with a tube and shell reactor having spirally positioned fluid inlets.

In US2007/0092436 a system is described that is distinct from fired reformer systems. In fired reformer systems a fuel is combusted in a radiant section to heat the reformer reaction unit(s) present in the radiant sections. US2007/0092436 makes use of an ATR type of reactor (partial oxidation reactor) to provide heat for an endothermal reforming reaction, instead of burners. Such type of reactor has no use for nor any benefit from using hydrogen fuel; e.g. the hydrogen fuel would not contribute to reducing duty or greenhouse gas emissions, if applied in the partial oxidation reactor. A specific drawback of the use of partial oxidation to provide the needed heat for the endothermal reforming reaction is the need for high pressure oxygen (or air) for the autothermal reformer. As described in US2007/0092436, the process requires a significant amount of oxygen or—in principle—air. The use of air has the specific aspect of introducing nitrogen, which is generally an undesired inert component in the reforming process and the resultant product. Removal of nitrogen from the product adds to the complexity of the process and decreases the energy efficiency as well as requiring a purge for the nitrogen. On the other hand, pure oxygen needs to be obtained making use of an energy intensive process, e.g. by making use of an air separation unit; and thus the use of pure oxygen contributes to a high power consumption. Additionally the heat integration proposed in US2007/0092436, typically results in insufficient duty available for producing process steam internally. Consequently an external boiler (either fired or electric) would be required, also resulting in additional energy requirements.

A continuing need exists to provide alternative processes and equipment to reduce greenhouse gas emissions (carbon dioxide, methane), e.g. to allow refurbishment of existing HPU's. In particular, a continuing need exists to provide an efficient way to produce hydrogen from hydrocarbon feeds by reformation processes, whereby in particular the same hydrogen production capacity can be maintained with smaller reformer systems, and/or whereby greenhouse gas emissions (carbon dioxide and/or methane) are (further) reduced and/or whereby global carbon footprint is (further) reduced. In particular, it would be desired to reduce the hydrocarbon consumption (i.e. use of hydrocarbon for other purposes than generating hydrogen product gas from it) in combination with providing a possibility to reduce the needed carbon dioxide capture flow rate in order to be able to reduce carbon dioxide emissions.

It is an object of the present invention to address one or more of said needs. One or more alternative or additional objects which may be addressed follow from the description below.

The inventors now found that one or more objects of the invention are addressed by using a specific arrangement of the reformer system in combination with using part of the produced hydrogen as fuel for heating the hydrocarbon in the reformer reaction unit.

Accordingly, the present invention relates to a process for producing a hydrogen-comprising product gas from a hydrocarbon, comprising
feeding hydrocarbon feedstock and a further reactant selected from the group consisting of steam (providing water for a reaction with the hydrocarbon), carbon dioxide and mixtures thereof, into a reformer system comprising one or more reformer reaction units (5, 22), at least one radiant section (12) and at least one convection section (13), which radiant section (12) comprises burners that combust fuel thereby providing heat to at least one reformer reaction unit (5) and a flue gas, which flue gas flows from the radiant section to the convection section (13), where heat is recovered from the flue gas;
subjecting the hydrocarbon in the reformer system to a reaction with the water, carbon dioxide or mixture thereof under formation of a reformate, comprising hydrogen, carbon monoxide, carbon dioxide, water, and usually methane;
subjecting the reformate or a process gas obtained from the reformate by a further treatment of the reformate (e.g. a process gas obtained after a further reaction in a shift reactor zone (7) or a tail gas (10) obtained after recovery of hydrogen-comprising product gas (9) in a hydrogen recovery unit (8)) to a carbon dioxide removal treatment (20), thereby obtaining a carbon dioxide depleted process gas, comprising hydrogen;
obtaining the hydrogen-comprising product gas (9) from the carbon dioxide depleted process gas; and
using part of the hydrogen, produced from the reaction of hydrocarbon and water as a fuel in the radiant section (12).

Reformer reaction units in a process respectively plant according to the invention generally comprise a plurality of reformer reaction tubes, generally each having an inlet (30) for hydrocarbon feed and steam, a reaction zone (36) through which the hydrocarbon-steam mixture is fed and an outlet for reformate out of the unit (33). The reformer system in accordance with the invention comprises at least one fired reformer reaction unit (5), which generally comprises a plurality of reformer reaction tubes, situated in the radiant section (12). Fired reformer reactor unit are reformer reaction units positioned in the radiant section and thus (directly) receive heat from the radiant section (12).

Preferably, one or more fired reformer reactor units (5) are heat-recuperating reformer reactor units; a heat-recuperating reformer reactor unit is a reforming reactor unit wherein the reformate is used as a source of heat for heating the hydrocarbon, hydrogen and water inside the reformer unit (5). Thus, as is known in the art, heat-recuperating reformer reactor units typically comprise a reformer catalyst zone, wherein the reformate is formed and a reformate passage way downstream of the catalyst zone leading to reformate to the outlet of the heat-recuperating reformer reactor unit. The reformate passage way is arranged to transfer heat from said reformate present in the reformate passage way to said reformer catalyst zone. The transfer of heat is by heat conduction for at least a substantial part, typically via a heat conductive partition (P), typically a wall of a heat conductive material, between reformate passage way and catalyst zone. Thus, in recuperative reforming available heat from the reformate to the catalyst is directly used to provide at least part of the heat of reaction in the catalyst zone. More specifically the heat exchange is thus directly between reformate and the gas in the catalyst zone. The required duty to be supplied by firing is thus intrinsically reduced, and does not need to be (fully) recovered from the flue gasses from the radiant section.

In a further preferred embodiment, the reformer system comprises two or more reformer reactor units (5,22) in parallel, wherein at least one of said reformer units (22) is a heat-exchanger reformer reactor unit, located outside the radiant section (12) of the reformer system, and at least one other reformer unit (5) is a fired reformer unit, located inside the radiant section (12) of the reformer system. Either or both of said units in parallel are optionally heat-recuperating reformer units. A process or plant for such embodiment of the invention, generally comprises a plurality of fired reformer reaction units inside the radiant section and a plurality of heat-exchanger reformer reactor units, located outside the radiant section.

In particular, the invention relates to a process according to any of the claims 1-21.

Further, the invention relates to a hydrogen plant comprising
a reformer system comprising one or more reformer reaction units (5, 22) comprising an inlet for a gaseous mixture, comprising a hydrocarbon and at a further reactant selected from the group consisting of steam, carbon dioxide and mixtures thereof, the reformer system further comprising and an outlet for gaseous reformate, a radiant section (12) comprising burners configured to provide heat for heating the gaseous mixture in one or more reformer reaction units (5) and a convection section (13), wherein the reformer system comprises at least one heat-recuperating reformer reaction unit (5) having a reforming reaction zone (36) comprising a catalyst and downstream thereof, yet upstream of the outlet (33) for gaseous reformate, a heat recovery zone comprising a channel adapted for the reformate (32,34) to pass through and transfer heat from the reformate in the passage channel to said reaction zone,
or which reformer system comprises two or more reformer units (5,22) in parallel, wherein at least one of said parallel reformer units (5) is present in the radiant section (12) of the reformer system, and at least one reformer unit (22) is located outside the radiant section (12) of the reformer system,
the plant further preferably comprising a shift reactor zone (7), configured to subject reformate to a water gas shift reaction, the shift reactor zone having an inlet for reformate connected to the reformate outlet of the reformer system via a gas passage way (channel, tube, pipe, line) and an outlet for process gas produced from the reformate in the shift reactor zone;
the plant further comprising a unit (8) configured to obtain hydrogen product gas, in particular a hydrogen recovery unit or a methanation unit, downstream of the reformer system and—if present—downstream of the shift reactor zone (7) and having an inlet for process gas originating from the reformer reaction unit (5) or reformer reaction units (5,22) connected to the reformate outlet of the reformer reaction unit (5) respectively reformate outlets of the reformatted reaction units (5,22) via a gas passage way, in which passage way one or more units are optionally present to treat the reformate, preferably at least a shift reactor zone or one or more units to remove one or more unwanted components from the process gas, said unit (8) configured to obtain hydrogen product gas further comprising a gas outlet for the hydrogen product gas, connected to a passage way for withdrawing the product from the plant;
the plant comprises a carbon dioxide capture unit, configured to recover carbon dioxide from a process stream derived from the gaseous mixture comprising hydrocarbon and water, located downstream of the reformer system and upstream of the unit (8) configured to obtain hydrogen product gas or located downstream of the unit (8) configured to obtain hydrogen product gas from;
the hydrogen plant further comprising a passage way configured to feed a hydrogen-comprising gas stream recovered from a process gas derived from the hydrocarbon feed, which process gas may be the reformate, the process gas produced in the shift reactor zone or which hydrogen-comprising gas stream may be a part of the product gas formed in said hydrogen recovery unit.

The reformer reaction unit (5) in the radiant section 12 (the fired reaction unit), generally comprises a reformer tube or a plurality of reformer tubes, comprising a catalyst configured to catalyze the reforming reaction. Such catalyst is usually also present in a parallel reforming unit (22), in an embodiment wherein reforming reaction units are provided in parallel. In particular, (the reformer tube(s)) of a heat-recuperating reformer reaction unit preferably comprises a structured catalyst. This allows to achieve a higher throughput per reformer tube and as a result higher active surface area, while allowing for lower pressure drop compared to a conventional reformer tube, comprising a catalyst bed with loose or packed catalyst with equivalent catalyst surface density. This allows indeed to decrease the volume of catalyst needed to process a given amount of feed stock into syngas, compared to conventional packed catalyst pellets bed.

Hydrogen recovery units, such as pressure swing adsorption (PSA) units adapted to recover a hydrogen enriched product gas from a process gas containing hydrogen and hydrogen-selective gas membrane separators are particularly suitable to provide the hydrogen-comprising gas product in accordance with the invention. These allow the provision of a product gas that essentially consists of hydrogen. In particular, in case a the desired product gas may contain a substantial amount of methane, e.g. up to about 15 mol %, in particular up to about 10 mol %, a methanation unit would also be suitable.

In particular, the invention further relates to a hydrogen production plant according to any of the claims 22-29. A hydrogen production plant according to the invention is particularly suitable for carrying out a process according to the invention.

The invention is described more fully herein with reference to the accompanying drawings, in which embodiments of the invention are shown, including some optional elements, e.g. pre-treatment unit 3, shift reaction zone 7 or parallel reformer reaction unit 22. Also locations of units and process lines may deviate from what is schematically shown. E.g. in some embodiments a carbon dioxide capture unit may be provided downstream of a hydrogen recovery unit (8) for obtaining the hydrogen gas product, in a passage way for tail gas (10) to the radiant section (12). In the drawings, the absolute and relative sizes of systems, components, layers, and regions may be exaggerated for clarity. Embodiments may be described with reference to schematic and/or cross-section illustrations of possibly idealized embodiments and intermediate structures of the invention. In the description and drawings, like numbers refer to like elements throughout. Relative terms as well as derivatives thereof should be construed to refer to the orientation as then described or as shown in the drawing under discussion. These relative terms are for convenience of description and do not require that the system be constructed or operated in a particular orientation unless stated otherwise.

The skilled person will be able to design and operate suitable operational units of the hydrogen plant or used in a process according to the invention, using the present disclosure in combination with common general knowledge and optionally one or more of the documents cited herein. E.g. the skilled person will be able to provide suitable process/plant units (e.g. a reformer units, shift reactor zone units, carbon dioxide recovery units, hydrogen recovery units, heat exchanger units) and passage ways, e.g. pipes, lines, tubes or other channels for passing gases or liquids from one processing unit to another, directly or indirectly, based on the present disclosure, the cited documents and common general knowledge.

For the purpose of clarity and a concise description, features are described herein as part of the same or separate embodiments, however, it will be appreciated that the scope of the invention may include embodiments having combinations of all or some of the features described.

As used herein, the singular forms “a”, “an” and “the” are intended to include the plural forms as well—, e.g. “a reformer reaction unit” includes “reforming reactor units”; “a burner” includes “a plurality of burners”, etc, unless the context clearly indicates otherwise. The term “or” includes any and all combinations of one or more of the associated listed items, unless the context clearly indicates otherwise (e.g. if an “either . . . or” construction is used). It will be understood that the terms “comprises” and “comprising” specify the presence of stated features but do not preclude the presence or addition of one or more other features. It will be further understood that when a particular step of a method is referred to as subsequent to another step, it can directly follow said other step or one or more intermediate steps may be carried out before carrying out the particular step, unless specified otherwise. Likewise, it will be understood that when a connection between structures or components is described, e.g. a passage way, this connection may be established directly or through intermediate structures or components unless specified otherwise.

The term “(at least) substantial(ly)” or “(at least) essential(ly)” is generally used herein to indicate that it has the general character or function of that which is specified. When referring to a quantifiable feature, this term is in particular used to indicate that it is at least 75%, more in particular 90% or more, even more in particular 95% or more of the maximum of that feature. The term ‘essentially free’ is generally used herein to indicate that a substance is not present (below the detection limit achievable with analytical technology as available on the effective filing date) or present in such a low amount that it does not significantly affect the property of the product that is essentially free of said substance. In practice, in quantitative terms, a product is usually considered essentially free of a substance, if the content of the substance is 0-1 wt. %, in particular 0-0.5 wt. %, more in particular 0-0.1 wt. %.

In the context of this application, the term “about” includes in particular a deviation of 10% or less from the given value, more in particular 5%, more in particular 3% or less.

The term “process gas” is in particular used for a gas obtained in the process or plant according to the invention from the hydrocarbon feed and water (steam). Typically process gas is a valuable gas, as an intermediate product or end-product, unlike flue gas. Typically, it is used for gases obtained in the process or plant, comprising hydrogen. The process gas is thus typically derived from the hydrocarbon feed and steam, providing water for the reaction, by a reaction whereby hydrogen and oxide(s) of carbon are formed (reformate, the product obtained in the shift reactor product), which gas obtained in the reaction may have been further treated by recovery/purification step (carbon-dioxide depleted product, obtained in carbon dioxide capture unit; product gas comprising hydrogen), tail gas from a hydrogen recovery unit) or by further reaction, e.g. methanation (product gas comprising hydrogen, in a specific embodiment).

Reformate comprises H₂, CO, CO₂, usually water and usually methane. Further inert gas may be present in particular nitrogen. Water is usually present, such as unreacted steam, when steam is used as a further reactant. When using carbon dioxide as the further reaction (dry reforming), water is usually also formed: the primary reforming reaction (for methane) is CH₄+CO₂ [symbol] 2CO+2H₂. However, a secondary reaction usually also takes place, at least to some extent, whereby water is formed: CO₂+H₂ [symbol] CO+H₂O.

Shift reactor process gas is the intermediate product gas obtained after subjecting the reformate (which may have been further processed before being fed to the shift reactor zone) to a reaction in the shift reactor. It comprises H₂, CO, CO₂, usually water and usually methane. Further inert gas may be present in particular nitrogen.

Carbon dioxide-depleted process gas is the intermediate product gas obtained after subjecting the reformate or shift reactor process gas (which may have been further processed before being fed to carbon dioxide removal unit) to treatment whereby at least a substantial part, preferably essentially all carbon dioxide is removed from the process gas that has been fed into said unit. Carbon dioxide depleted product comprises H₂, CO and usually methane. Water may also be present. Further inert gas may be present in particular nitrogen.

The hydrogen-comprising product gas essentially consists of hydrogen or comprises hydrogen as the major component.

The term tail gas in particular refers to a side-product (or waste product) obtained when recovering the hydrogen-comprising product as a fraction of a process gas, such as carbon-depleted product. The term tail gas is thus used broadly herein, not only for side-product obtained by PSA but also by other hydrogen recovery techniques, e.g. by hydrogen selective membrane separation, wherein typically the hydrogen comprising product gas is obtained as a permeate and the side product (tail gas) is the retentate. The tail gas generally comprises H₂, CO and usually methane.

### BRIEF DESCRIPTION OF THE DRAWINGS

FIG. 1 schematically shows a traditional hydrogen production facility, wherein hydrogen is produced by steam reforming, including optional elements.

FIG. 2 schematically shows a first preferred embodiment of the invention, including optional elements.

FIGS. 3A and 3B schematically shows two preferred configurations of heat-recuperating reformer reactor units; only a single reformer tube is shown, in practice general a plurality of those (in parallel) is provided (in case of a fired reformer reaction unit: a plurality of tubes in a single radiant section).

FIG. 4 schematically shows a second preferred embodiment of the invention, including optional elements.

FIGS. 5A and 5B schematically shows to examples of heat-exchanger reformers, suitable for use as a parallel reformer in accordance with the invention.

It is particularly advantageous aspect of the present invention that it allows direct heat transfer from the reformate formed in the fired reformer unit to a mixture of hydrocarbon feed and further reactant (steam, carbon dioxide or a mixture thereof) taking place inside a reformer unit. Thus, heat transfer typically takes place for at least a substantial part by conduction rather than by convection, as is the case when a feed for a reformer unit is pre-heated by flue gasses. The reformer unit wherein the heat transfer takes place can be the fired reforming unit (in case a heat-recuperating reformer unit is used) or reformate effluent from the fired reformer unit can be fed as a heat exchange medium to a (non-fired) parallel heat-exchanger reforming unit. Further, heat transfer to the hydrocarbon and further reaction inside the reformer is advantageous because thereby part of the needed heat for the reaction is directly supplied where it is needed for the reforming reaction (i.e. in the reformer catalyst zone). The concept of the present invention thus allows intrinsically a reduction of the firing as well and because of that reduces the amount of fuel to be fired. In this respect it should also be noted that there is a limitation to the amount of heat that can be used for pre-heating of the feed, as the inlet temperature of the feed into the reformer unit is limited due to the risk of carbon formation, if the feed is pre-heated to too high a temperature before being contacted with the reformer catalyst. Additionally, due to the endothermal nature of the steam reforming reaction a higher inlet temperature does not reduce the required firing duty significantly as the majority of the heat is required for the heat of reaction. The direct heating of the reforming reaction unit with recuperative reformer or a parallel non-fired reformer unit thus provides for further heat integration compared to heating the feed upstream of the reformer.

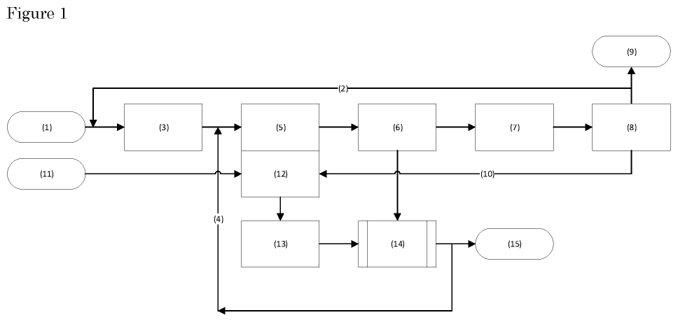

More in particular, the present invention allows a large reduction of CO₂ emission compared to a known endothermal reforming process, making use of a fired reformer, without (significant) increase of hydrocarbon consumption (or even reduction of hydrocarbon consumption) while avoiding energy intensive flue gas carbon capture. In particular for methane steam reforming are reduction by more than 80% is feasible compared to a base case as illustrated by FIG. 1 (case 1A) in the Examples, without (significant) increase of hydrocarbon consumption (or even reduction of hydrocarbon consumption) while avoiding energy intensive flue gas carbon capture. A reduction of more than 60% of the CO₂ emissions is feasible compared to a standard SMR with CO₂ capture from the process gas (which is a typical industry standard).

In a process according to the invention, hydrogen produced from hydrocarbon feed is used as fuel. When the further reforming reactant comprises steam, carbon dioxide is formed as a side-product in order to obtain said hydrogen and forms part of the reformate (a process gas), rather than being formed by combustion of hydrocarbon in the radiant zone. In dry forming unreacted carbon dioxide, this carbon dioxide also forms part of the reformate. Hereby, the CO₂ can conveniently be captured from the process gas, together with CO₂ formed to produce the part of the hydrogen that becomes (part of) the hydrogen-comprising product, withdrawn from the process, rather than being emitted to the atmosphere. As the hydrogen firing increases the feed consumption as more hydrogen is required, therefore either recuperative reforming and/or parallel heat exchange reformer reactor is applied to minimize the firing in the reformer. Thus, the design of the reformer and the use of the produced hydrogen act in combination to reduce greenhouse gas emissions and/or global carbon foot print. By further combining the reformer configuration, the use of hydrogen firing with carbon dioxide capture to remove carbon dioxide from process gas (reformate, shift reactor product) the carbon foot print is further reduced.

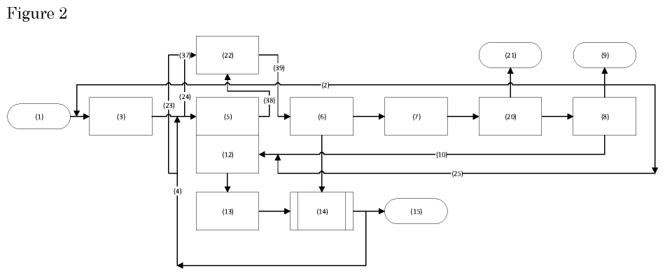

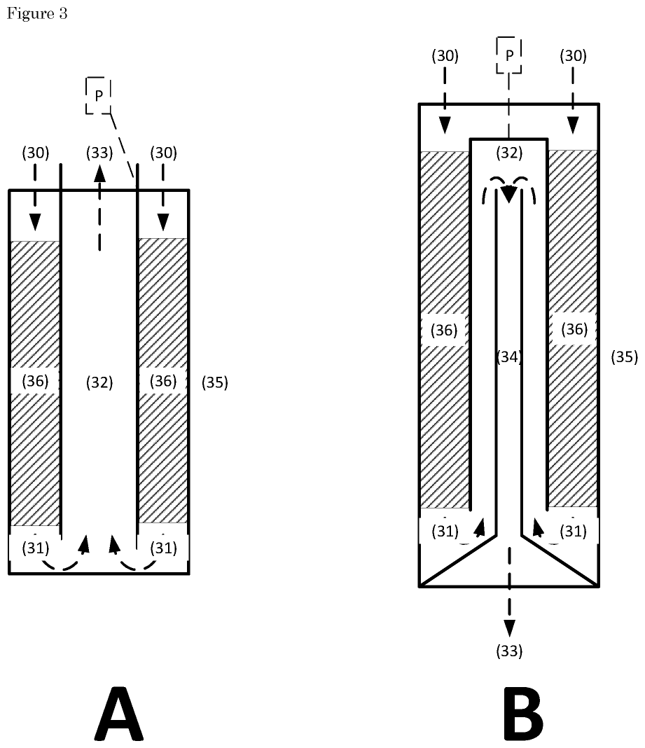

The present invention allows high severity reforming, especially when a heat recuperative reforming reaction unit is provided. Although heat recuperative reforming allows even higher severity, or uses of heat exchanger reformer unit (22) in parallel to a fired reformer unit (5) in combination with hydrogen firing and optionally other measures as described herein are also effective in reducing carbon dioxide emissions. In preferred embodiments, the present invention allows a reduction of about 90% or more of the direct CO₂ emissions of a hydrogen plant, while at the least in a number of embodiments also reducing the hydrocarbon feedstock and CO₂ captured. As illustrated in the Examples, very large savings in carbon dioxide emissions, global carbon dioxide foot print and the size of the reformer system are achievable, compared to comparative case 1A (based on a process as schematically show in FIG. 1 without carbon dioxide capture) and compared to comparative case 1B (with carbon dioxide capture and a combustion air preheat (APH) up to about 550 degrees C.). by using part of the hydrogen produced in the process to replace carbon-based fuel (needed in the process of FIG. 1) as fuel for heating the gas that is converted in the reformer into the reformate and capturing carbon dioxide (reference case 2, schematically shown in FIG. 2, without parallel reformer reaction unit 22 and wherein reformer reaction unit 5 is standard reformer tube filled with a catalyst bed consisting of pellets); Table 1 illustrates that in this example, in case 1B (with carbon dioxide capture) a 70% reduction in CO₂ emissions is realized, and that from the remaining 30% emissions, more than half is avoided by using hydrogen firing, leaving 12.8% of the emissions compared to case 1A. Of the remaining 12.8% of the carbon dioxide emission, about another tenth is avoided by replacing the standard reforming system for a reforming system making use of recuperative reforming. Expressed differently this increase of the carbon removal rate is best materialized in the avoidance of total hydrocarbon feedstock that sums up to 9.5%, i.e. an absolute global carbon footprint reduction of 10.2% (Case 3; based on FIG. 2, using a heat-recuperating reformer unit comprising a reformer tube containing an outer reaction channel containing catalyst bed and an inner heat recovery channel, configured to exchange heat with the outer reactor channel, said heat recovery extending coaxially inside the outer reactor channel, schematically shown in FIG. 3). Considering that removal of CO₂ becomes progressionally more difficult, this is already a significant improvement. Further significant savings in carbon dioxide emissions and global carbon dioxide foot print are achievable. In particular, the Examples illustrate that the combination of the heat-recuperative or parallel reformer with recycling of tail gas from the hydrogen recovery unit (such as a PSA or hydrogen selective membrane separator), allows for a reduction of 98% or more compared to a classical process without carbon dioxide capture (Case 1A,), a reduction of about 95% or more compared to a conventional process with carbon dioxide capture (Case 1B) and about 88% or more compared to reference Case 2.

It is further, noteworthy that the Examples illustrate that the invention allows a further reduction in carbon dioxide emissions without the need to increase the reformer size or only marginally increasing the reformer size compared to a conventional design, as exemplified by case 1A and case 1B at least in some embodiments, and to operate using a considerably smaller reformer size than in a reference case with hydrogen firing but with a standard reformer design (non-recuperative/non-parallel, cases 2 and 4). In fact, the complete plant size, including the front-end desulfurization (3) and the back-end shift (7) and purification (such as carbon dioxide capture, hydrogen recovery) can be reduced compared to what needs to be done when such hydrogen firing is adopted without the recuperative reforming or the parallel reformer concept in accordance with the invention. Yet another advantageous effect illustrated in the examples is the reduction in hydrocarbon consumption, when comparing case 3 with reference case 2, with case 1A or with case 1B, and when comparing case 5 with reference case 4 and case 1A; compared to case 1B, case 5 has about the same hydrocarbon consumption.

Next, processes and plants according to the invention are described in further detail.

The hydrocarbon feedstock (1) fed into the reformer system can be any hydrocarbon feedstock suitable for being subjected to reformation by reaction with water. It can in particular be a feedstock wherein the hydrocarbon is a feedstock at least substantially consisting of methane, such as natural gas or a biogas-based methane stream; propane gas (LPG), naphtha or refinery off-gas.

Dependent on the purity of the feedstock, the feedstock may be subjected to a pre-treatment in a pre-treatment section (3), such as hydrodesulphurization. Pre-treatments, conditions therefore and suitable pre-treatment units, may be based on known technology. In particular, when using a pre-treatment such as hydrodesulphurization, a make-up stream comprising hydrogen is usually added to the feed to ensure purification of the feed in the hydrodesulphurization section. As discussed below, a stream comprising hydrogen produced in a process according to the invention can be used to that purpose, in particular hydrogen product gas or tail gas from a hydrogen recovery unit.

The hydrocarbon feedstock is mixed with further reformate reactant, i.e. water (steam), carbon dioxide or a mixture thereof, before being subjected to the reaction in the reformer reaction unit (5 and optionally 22). Optionally a pre-reformer reaction unit is provided, upstream of the fired reformer reaction unit (5), and—if present—upstream of the parallel heat exchanger reformer outside the radiant section (12). The use of one or more pre-reformer units, usually one or more adiabatic pre-reformer units, to partially perform the reforming reaction (before preheating the pre-reformed mixture to the inlet temperature of the main reformer), is advantageous to unload the duty of the reforming reaction. In the pre-reforming, generally a minor part of the hydrocarbon is converted, whereby—amongst others—CO is formed.

The mixture to be fed into the reformer (or pre-reformer(s) in case a pre-reformer is used) usually at least substantially consists of hydrocarbon and the further reactant.

The use of steam as a further reformer reactant is generally known in the art, and described also in detail in the above cited prior art. Alternatively, instead of the addition of steam (3), part of the steam or the complete steam quantity can be replaced with carbon dioxide. Resulting in a reforming section feed (4) consisting of the hydrocarbon feedstock, carbon dioxide and possibly steam. The use of carbon dioxide for the reforming reaction is known in the art ad dry reforming (DRM). The skilled person will be able to determine suitable conditions based on the teaching in the present disclosure, common general knowledge and e.g. Mohamad H A, A mini-review on CO₂ Reforming of Methane, Progress Petrochem. Sci. 2(2) PPS.000532.2018.

Steam and hydrocarbon feed may be fed in ratio's known in the art. Usually the ratio hydrocarbon to steam fed into the reformer reaction unit is at least 2.0 mol/mol, preferably at least 2.5 mol/mol, in particular at least 3.0 mol/mol. Usually the ratio hydrocarbon to steam fed into the reformer reaction unit is 5.0 mol/mol or less, preferably 4.0 mol/mol or les, more preferably about 3.0 mol/mol or less. A ratio of hydrocarbon to steam ratio of 2.5 to 3.0 mol/mol is generally preferred as this results in the minimized hydrocarbon consumption and CO₂ emissions.

In particular if carbon dioxide is used as essentially the sole further reformer reactant, the ratio of hydrocarbon to CO₂ usually is at least about 2 mol/mol, preferably at least about 2.5 mol/mol, in particular about 3.0 mol/mol or more. In particular if carbon dioxide is used as essentially the sole further reformer reactant, the ratio of hydrocarbon to CO₂ usually is 6 mol/mol or less, preferably 5 mol/mol or less, in particular about 3 mol/mol. If a mixture of further reactions is used, suitable and preferred ratios can be calculated based on the ratio steam/CO₂ and the above ratios, wherein about stoichiometric ratios are particularly preferred.

In accordance with the invention, the required fired duty for driving the reforming reactions in the reformer reaction unit is reduced by applying a recuperative reformer reaction unit (5) located in the radiant section (12) and/or a parallel heat exchanger (22) reforming reactor outside the radiant section (12) of the reformer system. As already explained, such reduction in fired duty would not be achieved by extra pre-heating of the feed before entering the reformer reaction unity.

Both embodiments wherein a heat-recuperative reformer reaction unit (5; in the radiant section 12) is provided and embodiments wherein two or more reformer reaction units (5,12) are provided in parallel, allow for high severity reforming, compared to standard reformer systems. The presence/use of a heat-recuperative reforming reaction unit as a fired reformer reaction unit (5), especially in combination with structured catalyst present therein, allows for higher throughput due to increase heat transfer and lower pressure drop as well as the heat recovered, in comparison to a standard fired reformer system and system with (non heat recuperating reformer reaction units in parallel). Additionally, it avoids temperature limitations for materials thereby allowing catalyst outlet temperature of far above 900 degrees C. (typically up to 1000 degrees C.), whilst remaining efficient. The advantage of the high outlet temperature is more conversion of CH₄ and thus a lower carbon footprint and more hydrogen produced.

In recuperative reforming, internal heat is recovered inside the reformer reaction unit (5). Advantageously, the heat-recuperating reformer unit, comprises an outer reactor channel (36) and an inner heat recovery channel (32), configured to exchange heat with the outer reactor channel, said heat recovery extending coaxially inside the outer reactor channel; said inner and outer channel together are also referred to in the art as forming a reformer tube. The outer reactor channel generally contains a catalyst, usually a catalyst bed, catalysing the reaction between the hydrocarbon and the water under formation of reformate. Suitable catalysts are generally known in the art. Particularly suitable is a nickel catalyst (a catalyst comprising metallic nickel or nickel oxide), which usually is provided on a ceramic support, e.g. alumina. The outer reactor channel has a feed inlet (30) via which, during use, the hydrocarbon and the water are brought in contact with the catalyst (fed through the bed) and an outlet (31) for reformate, which inlet and outlet are located at opposite ends of the outer channel containing the catalyst. At least a substantial part of the inner channel (32, 34) and at least a substantial part of the outer channel are separated via a heat-conductive partition (P), allowing heat transfer from the inner channel (reformate passage way 32, 34) to the outer channel (catalyst zone 36) by heat conduction for at least a substantial part, directly via said partition (P), such as a heat conductive wall. Thus, heat is transferred internally inside the reformer reaction unit without transfer of heat to another gaseous medium than the medium present in the catalyst zone, let alone another gaseous medium outside the reformer reaction unit such as flue gas in the radiant section or in a convection section. A further part of the required heat for the endothermic reforming reaction is provided by firing of fuel in the radiant section (35). During use, the reformate is fed from outlet (31) into the inner channel (32, 34). Heat is then transferred from the reformate flowing through the inner channel to the contents of the outer reactor channel and reformate leaves the heat-recuperating reformer unit via a gas outlet (33).

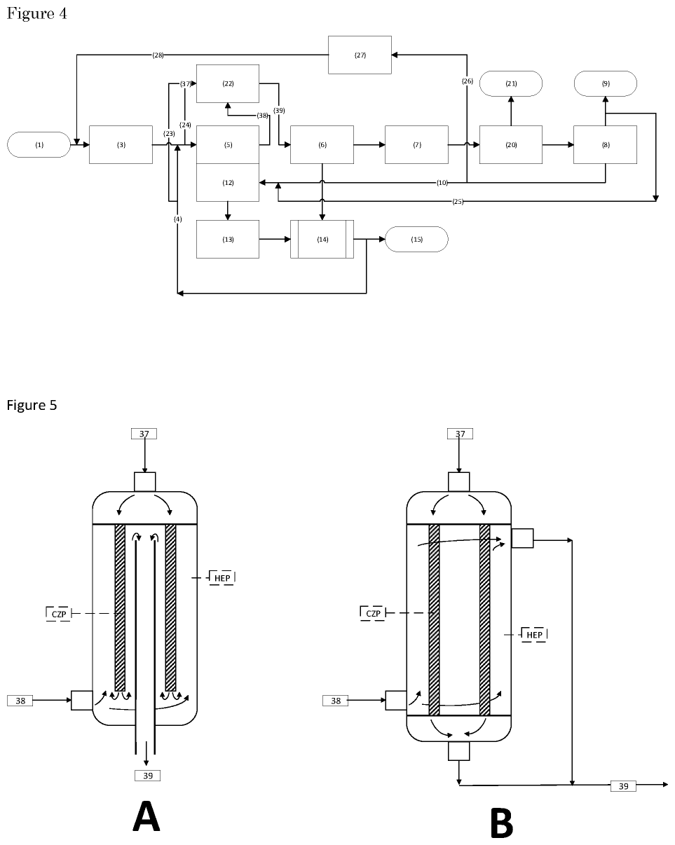

FIG. 3 schematically shows two concepts of preferred recuperative reforming reaction units. In recuperative reforming, the reformer inlet gas (30) usually has an temperature at the inlet in the range of about 350 to about 700 degrees C., preferably in the range of 500 to 700° C. Heat is supplied by both the internal heat recovery (34) and by firing of fuel in the radiant section (35 in FIG. 3, cf. 12 in FIGS. 2 and 4). The recuperative reformer reaction unit is usually configured (and operated) to provide a temperature in the range of about 700 to about 1000° C., preferably of 900° C. or higher, of the reformate gas at the outlet (31) side of the part of the unit provided with catalyst (the outlet-end of the catalyst bed) The reformer configuration of the present invention allows a robust operation, also at a high reaction temperature (see also below). The higher the outlet temperature, the more of the methane reacts to H₂ and oxides or carbon, ultimately CO₂ (which is captured), and thus lower hydrocarbon consumption to produce the same amount of hydrogen. A higher temperature increases firing demand, but as—in accordance with the invention it is possible to perform most (or in some embodiments essentially all) of the firing with hydrogen a savings in CO₂ emissions is still feasible, also when operating at about 1000 degrees C. Although a high methane conversion rate is advantageous, it is not necessary in a process according to the invention that all methane is consumed in the reformer system.

The pressure in the reformer reaction unit can be chosen within a known range, generally between 0.1 and 10 MPa, e.g. depending on the desired product pressure. Advantageously the pressure in a process according to the invention is at least 0.2 MPa, in particular at least 0.25 MPa. Usually, the pressure in the reformer reaction zone is 5 MPa or less, preferably 4 MPa or less, more preferably in the range of 0.2-4.0 MPa.

The hot reformed gas then flows counter-currently (34) back and cools down the gas by supplying heat to the reacting gas and reformer product. The outlet temperature of the reformate optionally makes a further pass through an innermost channel (32), typically co-current with the catalyst. The temperature of the reformate is usually about 30-100° C. above the inlet temperature when exiting the reformer tube (33),

Concept A in FIG. 3 (left hand) shows a reformer tube with two passes, where the inlet reacts through a catalyst bed and hot gas is collected and flows countercurrently while exchanging heat with the reaction zone. The inlet and outlet of the gas are thus at the side of the tube. Concept B of FIG. 3 (right hand) adds a third pass where the cooled gas (32) flows counter currently in an additional inner channel to exit the reformer tube at the opposite side of the inlet (33).

The internal heat recovery significantly decreases the required fired duty of the radiant section (12) and subsequently reduces the need for externally applied fuel (11) and eventually the associated CO₂ emissions. By combining measures in accordance with the invention making at least making use of a recuperative reformer unit or parallel reforming unit and using hydrogen produced in the process of the invention it has been found possible to fully provide the needed heat for producing the hydrogen product from a fraction of the product obtained by converting the hydrocarbon feed. The fuel needed for obtaining the hydrogen-comprising product in accordance with the invention can be a part of said product, can be a combination of tail gas (10) obtained after recovering the hydrogen comprising product (9) in a hydrogen recovery unit (8) and the product gas comprising hydrogen recovered in said unit. It is also possible to obtain the needed hydrogen from another process gas made from the hydrocarbon feed (such as a hydrogen-enriched gas obtained after reformer (directly or further downstream). If desired, a minor part of the fuel (<50% of the calorific value, in particular less than 25% of the calorific value) can be provided by an external source (i.e. other than—indirectly—from the hydrocarbon feed) though. In practice this is usually not preferred, in particular not if the external fuel adds directly or indirectly to carbon dioxide emissions.

In addition, the concept of recuperative reforming also enables high severity reforming, because the location of the highest temperature reached by the process, is towards the outlet side of the catalyst (bed) that is not in direct fluid connection with the outlet system manifolds. This latter aspect is an important differentiator with standard steam- or dry reforming reactors having no internal recirculation and where outlet manifold are exposed to the same severe conditions as the outlet of the catalyst bed is exposed to. Such exposure brings challenges and limitations for the mechanical design of the outlet system, that is classically a bottleneck for the design of reformers operating with low methane slip. In short: recuperative reforming design allows for reaching severe reforming conditions (and thus low methane slip) while using sound mechanical concept for the process unit, in particular by reducing the need of additional firing compared to conventional reforming technology.

The inventors found that a typical application of recuperative reforming in accordance with the invention results in 10 to 20% of the heat recovered in the tube and thereby 10 to 20% smaller reformer size compared to a conventional reformer. Unexpectedly the difference between a conventional and a recuperative reforming configuration according to the invention with hydrogen firing (and optional tail gas recycle from the hydrogen recovery unit may reach up to 40% reduction in reformer size (cf Examples: Case 3 of the invention vs. Reference Case 2 and Case 5 of the invention vs. Reference Case 4). The inventors realized that reducing the size of the reformer is possible by unloading part of the fired duty in the reformer, and thus lowering the hydrogen required for firing, which in terms reduces the hydrogen to be produced and thereby further reducing the firing demand. This cumulative effect resulted unexpectedly in a reduction of more than 30% of the reformer size. Thereby eliminating the larger reformer size required to produce the hydrogen for firing. In case this is combined with a recycle of tail gas to the front-end of the plant, this cumulative effect is amplified even more and resulting in a more than 40% reduction in reformer size when applying recuperative reforming compared to conventional reforming.

Alternatively, for a parallel heat exchanger reformer where typically the reformer duty is reduced by 20% for the same production capacity, however when applied as described in this invention the cumulative effect of the reduction in reformer fired duty and thus lower hydrogen production (and/or tail gas recycle) results in a reduction of the reformer size by more than 40%.

An additional benefit is obtained if the specific reforming concept provided in a process or plant according to the invention, i.e. the recuperative reforming or the parallel reformer unit concept, is combined with a structured catalyst. This allows for higher throughput per reformer tube as a result of reduced pressure drop and high active surface area. This combination enables further increase of the throughput per tube and thus decreasing the reformer size. A major advantage of the invention is thus achieved by means of recuperative reforming in combination with the structured catalyst. The recuperative reforming recovers part of the heat from the reforming reaction directly from the hot effluent and therefore reduces the required firing in the reformer. As hydrogen produced in the process of the invention is used for firing, the reduction in firing reduces the required hydrogen produced and subsequently the hydrocarbon consumption by up to about 10%, or up to about 15%, when tail gas is recycled from a hydrogen recovery unit. Unexpectedly, the combined effect of the reduced firing hand the lower hydrogen consumption for firing allows the reduction the reformer size by about 2030% in a typical embodiment. Subsequently, the rest of the plant size—including the usually present CO₂ removal unit—can also be reduced by about 10-15%. Such reduction has not been experienced when employing a reformer system comprising a recuperative fired reformer reaction unit, without using hydrogen as fuel derived from reformate. The inventors also found a reduction in power demand, thereby reducing the global CO₂ footprint even further.

The catalyst in a heat-recuperative reformer reaction unit preferably is a structured catalyst. Examples of structured catalysts suitable for use in a steam reforming or dry reforming process or hydrogen plant in accordance with the invention are known per se. The catalyst preferably has an annular configuration. An advantage of an annular configuration is the ability of the reforming tubular reactor to process higher feedstock flow rate and recycled gas flowrate and therefore allows for avoiding the increase in size of the reformer, which may be a steam reformer or a dry reformer, compared to the conventional reforming process. Advantageously, the catalyst structure is pre-formed into an annular structure or composed of several pre-formed parts, together forming an annular structure. Advantageous catalyst structures for a reformer reaction system in accordance with the invention can be based on the contents of PCT/EP2020/068035 of which the contents are incorporated by reference, in particular the claims and figures. Thus, in an advantageous embodiment, the heat recuperative reformer comprises a catalyst tube assembly, comprising
an outer reactor tube having an inlet end and an outlet end opposite the inlet end, and including an inwardly protruding element;
a centering assembly including an inner tube having an inlet end and an outlet end;
a tubular boundary having a closed end and an open end;
wherein the tubular boundary is configured to extend substantially coaxially within the outer reactor tube and substantially coaxially around the inner tube, such that the catalyst tube assembly includes a first annular channel between the outer reactor tube and the tubular boundary, and a second annular channel between the tubular boundary and the inner tube, wherein the second annular channel is in fluid connection with the first annular channel near the open end of the tubular boundary, and in fluid connection with the inner tube at the closed end of the tubular boundary
wherein the outlet end of the inner tube includes at least one sealing member configured to be in sealing engagement with the inwardly protruding element of the outer reactor tube.

The structured catalyst may be a catalytic material coated on a monolith or corrugated plate, enhancing the heat transfer properties in the inside of the tube. Examples are shown in e.g., US2010/0254864. Examples of annular catalysts in a recuperative reformer tube are shown in WO 97/26985. The annular reactor consists of a U-tube reactor (or Bayonet type reactor) that contains a riser tube in its central part. The catalyst is arranged in the annular space and the process gas flows back upwards in the central riser. The process gas is collected on the top side. Both process gas inlet and outlet system are therefore on the top side of the reactor assembly. WO 97/26985 also shows a tube surrounding the U-tube reactor (or Bayonet type reactor) where the combustion flue gas are circulated and provide the heat necessary for the reforming reaction. The combustion occurs in an externally located burner and the flue gas are brought in contact with the reactor via a jacketed cylindrical chamber surrounding the reactor.

A further, example is shown in US2007/0025893. It shows a reactor design with stackable structures placed in annular configuration inside the reforming reactor.

Further, the recuperative reformer reaction unit may e.g. be based on EP-A 0 725 675, U.S. Pat. Nos. 5,162,104, 5,219,535 or WO 2018/077969. The recuperative reformer reaction unit is advantageously based on a catalyst tube design described in WO2018/077969 of which the contents, in particular the claims and the figures, are incorporated by reference. Thus, with reference to claim 1 and FIG. 1 of WO2018/077969, advantageously the recuperative reformer reaction unit comprises a catalyst tube for regenerative catalytic conversion of process gas in an industrial furnace comprising
a catalyst tube inlet for gaseous hydrocarbon feed to enter the catalyst tube and a catalyst tube outlet for reformate s to exit the catalyst tube, which inlet and outlet are located at opposite ends of the catalyst tube;
an outer reactor tube;
an inner tube that extends coaxially inside the outer reactor tube;
a boundary located between the inner wall of the outer reactor tube and the outer wall of the inner tube;
a first annular channel for catalytically converting the hydrocarbon feed in the presence of water, which channel is defined by the inner wall of the outer reactor tube and the outer wall of the boundary, which channel contains the catalyst;
a second annular channel for reformate to flow counter-currently or co-currently to the feed flowing through the first annular channel, which second annular channel is defined by the inner wall of the boundary and the outer wall of the inner tube;
an inlet barrier at the inlet end of the catalyst tube for preventing gas to exit the outer reactor tube from the second annular channel and inner tube (at the inlet end of the catalyst tube;
an outlet barrier at the outlet end of the catalyst tube for preventing gas to exit the outer reactor tube (1,11) from the first annular channel and from one of the second annular channel and the inner tube, while allowing gas to exit the outer reactor tube from the other of the second annular channel and the inner tube;
wherein the inner tube, first annular channel and second annular channel each have an opening at the inlet side of the catalyst tube and an opening at the outlet side of the catalyst tube,
wherein the catalyst tube inlet is fluidly connected with the opening of the first annular channel at the inlet end of the catalyst tube; the opening of the first annular channel at the outlet end of the catalyst tube is fluidly connected with either the opening of the second annular channel at the outlet end of the catalyst tube or the opening of the inner tube at the outlet end of the catalyst tube; the opening of the second annular channel at the inlet end of the catalyst tube is fluidly connected with the opening of the inner tube at the inlet end of the catalyst tube; and either the opening of the inner tube at the outlet end of the catalyst tube or the opening of the second annular channel at the outlet end of the catalyst tube is fluidly connected with the catalyst tube outlet.

With respect to WO2018/0077969 it is observed that this document does not specifically teach to reduce CO₂ emissions in a steam reforming or dry reforming process as is achievable by the present invention. The inventors found that in accordance with the present invention, a cumulative effect is achieved on the reduction of hydrocarbon feed and CO₂ emissions. The recuperative reforming reduces the firing, requires less hydrogen to be formed in the reformer and therefore the firing is again less and thus the reduction effect of recuperative reforming is significantly increased.

Alternatively or in combination with the recuperative reformer unit (5), a parallel heat exchanger reformer unit (22) is provided in a process or plant according to the invention. The heat exchanger reformer may be based on a heat exchanger known in the art, e.g. from WO2018/104526, of which the contents, in particular the claims and figures are incorporated herein by reference.

The parallel reformate or part thereof and the reformate from the fired reformer or part thereof that has been used as heat exchange medium in the heat-exchanging medium passage way (HEP) are usually combined downstream of the parallel reformer catalyst zone (CZP) and downstream of the heat exchanging medium passage way (HEP), thereby forming a combined reformate gas (39). The combining can take place downstream of the parallel reformer catalyst zone, yet inside the parallel reformer unit or outside the parallel reformer unit.

FIG. 5A schematically shows a design for combining inside the parallel reformer. This makes the mechanical design simpler, but could require an increase in heat-exchange area due to lower temperature difference. FIG. 5B schematically shows a design for combining inside the parallel reformer outside the reformer, which can add to the complexity of the design, but can reduce the required heat-exchange area. As illustrated in FIGS. 5A and 5B the parallel heat exchanger reformer comprises a first passage way for the hydrocarbon plus further reacted to be subjected to the reforming reaction. This passage way comprises an inlet for the hydrocarbon-further reactant mixture (37), a reformer catalyst zone (CZP), and an outlet for reformate from the reformer reaction unit (FIG. 5B) or combined reformate from the reformer reaction unit and reformate originating from the primary reformer that has been used as a heat exchange medium. The combined reformate (38) is then typically fed to a down-stream processing unit. The heat exchanger reformer further comprises a second passage way, i.e. a heat transfer passage way (HEP), arranged to transfer heat from the heat exchange medium in the second passage way to the reformer catalyst zone (CZP). Heat exchange medium (38) is hot reformate originating from the primary reformer (and optionally the secondary reformer) entering heat exchanger reformer via an inlet into the second passage way and leaving the parallel reformer via the same outlet as the reformate formed in the heat exchanger reformer (FIG. 5A) or via a separate outlet (FIG. 5B).

A preferred heat exchanger reformer comprises a vessel having a plate assembly section placed therein comprising of several plates positioned at a distance from each other to provide at least alternating first and second channels between adjacent plates, which vessel comprises a first inlet at a first end of the plate assembly section for supplying a mixture of a hydrocarbon feed and further reactant (steam, carbon dioxide or mixture thereof) to the first channels and causing the mixture to flow in a direction toward a second end of the plate assembly section, which vessel also comprises a second inlet close to the second end of the plate assembly for supplying hot reformer effluent as a heating gas flow to the second channels, wherein the second channels comprise a first and a second section which are connected to each other, wherein the first section is provided for conducting the hot reformer effluent in a direction towards the first end of the plate assembly counter current to the flow of the hydrocarbon feed and further reactant mixture, e.g. steam mixture, in the first channels, and the second section is provided for conducting the hot reformer effluent to flow in cross direction of the first channels, which second channels are connected to a collector outlet for the reformer effluent to leave the heat exchanger reformer at the first end of the plate assembly.

The parallel heat exchanger reformer is installed outside (and in a parallel flow path for the mixture of hydrocarbon feed and steam (or carbon dioxide) of the radiant section (12) of the steam reformer system. The fired reformer reaction unit (5) located inside the radiant section can be a standard reformer reaction unit or a recuperative reformer reaction unit (for instance as schematically shown in FIG. 3). In a parallel configuration, a part of the feed to the reformer system is split off (24) and sent to a heat exchanger reforming reactor (22) parallel to the fired reformer (5). Heat for the reaction in the parallel (non-fired) heat exchanger reformer (22) is supplied by heat reformer effluent, heat available in the flue gas from the radiant section (12) or another high temperature heat source, generally of at least 850 degrees C., in particular of 900 degrees C. or higher.

An advantage of a parallel heat exchange reformer is that, during use, it supplies part of the duty required for hydrogen production, thereby reducing the required radiant duty in the reformer (provided in radiant section 12) and subsequently the required fired duty. Generally, the outlet temperature at the catalyst zone (bed) in the heat exchanger reformer unit is lower than in a fired reformer (typically the main reformer, i.e. receiving more than 50% of the feed-further reactant mixture, in particular feed-steam mixture) due to the temperature difference (the driving force) necessary for the heat exchange process to take place The outlet temperature of the catalyst bed is typically in the range of 750 to about 850 degrees C., with the proviso that it is lower than the outlet temperature of the fired reformer (5), usually at least about 20 degrees C. lower. The pressure in the parallel reformer (22) outside the radiant section is generally about equal to the pressure in the fired reformer. Accordingly, the methane slip is typically higher than in a reformer. To decrease the methane slip, additional steam (23) or carbon dioxide or a mixture thereof can be added at the feed of the parallel heat exchanger reactor (22) to drive the reforming reaction towards hydrogen production. Thus, the ratio of further reactant (steam, carbon dioxide, mixture thereof) to hydrocarbon feed, does not have to be the same in different reformer reaction units. The reformer effluent from the heat exchanger reformer unit (22) is typically combined with the reformer effluent from the fired reformer unit (5) before further processing, which generally comprises a further reaction in a entering the shift section (7), see also below. Because the heat exchanger reformer is parallel to the fired reformer and reduces the required duty of the fired reformer (when comparing at equal hydrogen output), the reformer size can be reduced with the same throughput per tube. When using a parallel configuration, usually about 10 to about 30 wt. % of the hydrocarbon feed, preferably 15-25 wt. % is fed to the (non-fired) heat exchanger reformer reaction unit (22). A higher split ratio will unload the reformer further, but reduce the driving force for the heat exchanger reformer, resulting in a increasingly larger parallel reformer exchanger.

The reformate is typically cooled (6) before further processing. This can be done in a manner known per se. Particularly useful is a waste heat boiler (6) wherein, during use, steam is produced using heat from the reformate stream. Steam is further preferably generated using heat from the flue gases from the radiant section (12). This is generally done in a heat exchanger (14) configured in a heat-exchanging configuration in the convection section (13). The produced steam (4, 23) or part thereof is used as the water to be reacted with the hydrocarbon feed to be subjected to reaction in the reformation. In principle, produced steam may also be combined with reformate prior to the shift reactor zone (7) or fed to the process gas inside the shift reactor. However, good results are achieved without adding steam to the reformate or inside the shift reactor zone. The process or plant according to the invention can be adapted to be completely self-sufficient in steam production for the process or based with export and/or import steam (15). The lower the required steam production inside the unit battery limits, the more heat integration can be applied and thus lower firing requirement.

The reformate, typically after cooling, is usually fed into a shift reactor zone (7), wherein carbon monoxide, reacts with water to form further hydrogen and carbon dioxide. This is usually done in the presence of a shift catalyst, which is known per se, e.g. an iron- or copper-based shift catalyst. Thus, the treatment in the shift reactor zone results in a shift reactor product (shift reactor process gas) having an increased hydrogen and carbon dioxide content compared to the reformate. The shift reactor zone design and reaction conditions may in principle be based on known technology, e.g. as described in the prior art cited herein.

The shift reaction zone is generally operated at a lower temperature than the reformer system. Generally, the temperature during shift reaction is in the range of about 190 to about 500 degrees C. The type of shift applied is generally indicated in three categories based on the outlet temperature of the catalyst. High temperature shift with an inlet of 300-400 degrees C. and outlet of 350-500 degrees C.; medium temperature shift with an inlet temperature of 190-230 degrees C. and an outlet temperature of 280-330 degrees C. and low temperature with an inlet temperature of 180-230 degrees C. and an outlet temperature of 200-250 degrees C. As the water gas shift reaction is exothermic, the temperature rise is larger for a higher CO concentration at the inlet.

For a low carbon dioxide emission, it is advantageous to operate the shift reactor zone under conditions wherein the water gas shift reaction (CO+H₂O [symbol] CO₂+H₂) is shifted towards the formation of H₂ and CO₂. As the reaction is exothermic, this favored by a low temperature. Preferably, a high temperature shift followed by low temperature shift is applied in a process according to the invention to maximize the CO conversion to H₂ and CO₂ (which CO₂ is thereafter captured) and thus minimize the CO₂ emissions. Alternatively, only a high temperature shift, a medium temperature shift reaction or an isothermal shift reaction (a cooled shift reactor at a constant temperature) can be applied).

Advantageously, at least the fired reformer reaction unit (5) is operated at a relatively high temperature, preferably in the range of 850-1000 degrees C., more preferably in the range of 900-1000 degrees C. (at the outlet end of the catalyst) and a deep shift conversion (resulting in a high CO conversion to CO₂), typically with an outlet temperature of the shift reactor in the range of 200-250 degrees C. is applied in the shift reactor zone to maximize the conversion of feed to hydrogen and thereby reducing the CO₂ emissions as well as the hydrocarbon consumption as per invention.

In a specific embodiment, the reformate is further processed to provide the hydrogen comprising product without making use of a shift reaction zone. This is in particular interesting in case it is desired to also recover CO as a product. In that case, also a CO recovery unit will be provided in the plant, adapted to remove CO from reformate or a process gas derived from the reformate.

Usually, in accordance with the invention, the reformate or the shift reactor process gas (the latter when—as is usual—a treatment in a shift reactor zone is carried out) is subjected to a carbon dioxide removal treatment (20). Herein, the carbon dioxide content in said reformate or shift reactor process gas is reduced to form a carbon dioxide-depleted process gas (carbon dioxide-depleted product) and a carbon dioxide side-product. Capturing the CO₂ can be accomplished in a manner known per se, e.g. as described in the cited prior art. Advantageous techniques are temperature swing adsorption (TSA), Vacuum Swing adsorption (VSA), Sorption enhanced Water-Gas shift (SEWGS) and amine-based adsorption/stripping process. Typically, amine-based adsorption/stripping process is preferred where all duty for the amine reboiler is supplied by the process gas and thereby minimizing the external heat input. Capturing CO₂ from the process gas (reformate or shift-reactor product) is preferred as this is the least energy intensive, as the process gas is available at high pressure (typically about 20-35 barg) and therefore has a high driving force for the separation of CO₂. The captured CO₂ is sent as a high purity stream to the battery limit (outgoing stream from the plant) and could be used for other process, food and beverage industry as well as for storage as in Carbon Capture for Utilization and Storage (CCUS). Further, captured CO₂ may be used as a reformer reactant, when applying a dry reforming process. This may be a reformer process different from the present reformer process; however, it is also possible to recycle a gas enriched in carbon dioxide obtained in the carbon dioxide removal treatment, directly or after further purification to higher carbon dioxide content, to one or more reformer reaction units (5, 22) in a process according to the invention.

Typically, from 70 up to 99% of the CO₂ is removed from the process gas, although technically 99.99+% removal of the CO₂ is possible; this corresponds to a reduction of the overall CO₂ emissions of the hydrogen production plant by about 30-60%.

Alternatively, a CO₂ removal unit is provided to recover CO₂ from the hydrogen recovery unit tail gas, in particular in a passage way (10) to burners of the radiant section (thereby avoiding emission via flue gases, if provided. If a recycle of tail gas is provided (27, 28) the tail gas to be recycled is also advantageously subjected to carbon dioxide removal, if not already CO₂ depleted, as this reduces the size of the recycle stream. The removal of CO₂ from the tail gas (typically operating at pressure from 0.3-1 barg in case of PSA) allows a similar reduction of CO₂ emissions as removal from the process gas. However, as the driving force on pressure is generally lower, than when carbon dioxide is captured from process gas upstream of the hydrogen recovery unit, where partial carbon dioxide pressures are usually over 1 barg, it is generally more energy intensive to capture carbon dioxide from the tail gas.

It is noted that CO₂ capture on conventional reforming with CO₂ removal in the flue gas is also known in the art, but this is very energy intensive and requires complicated technology compared to the present invention, especially when aiming to remove the carbon dioxide in a stream at least substantially. As illustrated in the examples, in accordance with the present invention it is possible to achieve more than 98% reduction in CO₂ emissions, by capturing it from a process gas (upstream of a unit wherein hydrogen product gas is obtained or in a tail gas from a hydrogen recovery unit) without the requirement of CO₂ capture from the flue gas. Also from a plant-size perspective it is advantageous not to use/provide a capturing device configured to remove carbon dioxide from flue gas. Still, in an (atypical) embodiment wherein the flue gas in a process according to the invention comprises a significant amount of carbon dioxide, additionally carbon dioxide capture from the flue gas is feasible.

The way of reforming in a process of the invention reduces the CO₂ production in the process gas significantly. In particular, in accordance with the invention it is possible to reduce the energy requirements for CO₂ separation from the process gas by at least 10%, due to the internal heat recovery provided by the design of the reformer system and the lower firing, at equal process configuration otherwise. Subsequently, the invention also decreases the energy required to remove CO₂ from the process gas, as well as the needed size of the recovery unit. The reduction in carbon footprint is therefore not only the reduction in firing, but also the reduced duty required to remove the CO₂ from the process gas.

As will be understood by the skilled person, the reformate, the shift reactor product respectively the carbon dioxide-depleted product still contain substantial amounts of components other than hydrogen. Accordingly, generally a hydrogen recovery (8) is carried out in order to obtain the hydrogen comprising product gas (9) of satisfactory purity, usually at least about 95 mol %, preferably at least 98% more preferably at least 99 mol. %, in particular at least 99.9 mol %. The purity may be 100% or less, in particular 99.9999% or less, 99.999% or less, 99.99% or less, 99.9% or less, 99.5% or less, 99.0% or less, dependent on the needs and technology used. Suitable techniques to recover hydrogen recovery from a process gas (such as reformate, shift reactor product respectively the carbon-dioxide depleted product) can be based on known technology, e.g. as described in the prior art. In a particularly preferred embodiment, a pressure swing adsorption (PSA) unit is provided. PSA allows the production of hydrogen gas that is essentially free of other components. In a further preferred embodiment, a hydrogen selective membrane separator is provided. In a further preferred embodiment, an electrochemical compressor is provided. Electrochemical compressors can be used to obtain high purity high pressure hydrogen-comprising product gas (9).

In a much preferred embodiment, reformate is subjected to a shift reaction in one shift reactor or two or more shift reactors in series, to obtain a shift reactor product, the shift reactor product is subjected to a carbon dioxide removal treatment (20) to obtain the carbon dioxide-depleted product and the gas enriched in hydrogen is recovered from the carbon dioxide-depleted product carbon-dioxide using the pressure swing adsorption treatment (8), the hydrogen-selective membrane (8) or the electrochemical compressor (8), thereby obtaining the hydrogen-comprising product gas, of which part is used as fuel in the radiant section of the reformer system. In a further preferred embodiment, the carbon dioxide-depleted product is separated into the gas enriched in hydrogen, preferably the hydrogen-comprising product, having an increased hydrogen content compared to the carbon dioxide-depleted product and a tail gas having a reduced hydrogen content compared to the carbon dioxide-depleted process stream, said tail gas comprising hydrocarbon and all or part of which tail gas product is used as fuel in the radiant section, preferably after mixing it with other fuel component or components, such as hydrogen-comprising product. In yet a further preferred embodiment, the carbon dioxide-depleted product is separated into the gas enriched in hydrogen, preferably the hydrogen-comprising product, having an increased hydrogen content compared to the carbon dioxide-depleted product and a tail gas having a reduced hydrogen content compared to the carbon dioxide-depleted process stream, said tail gas comprising hydrocarbon and all or part of which tail gas product is used as fuel in the radiant section, preferably after mixing it with other fuel component or components, such as hydrogen-comprising product.

Alternatively to a hydrogen recovery unit, such as a PSA or membrane separator, for relatively low product purity requirements, usually from about 90 to 99 vol % H₂, in particular 95-99 vol % H₂, the (traces of) CO in the CO₂-depleted stream can be converted into CH₄ using a methanation reaction unit. In this case, there is no additional separation step required to recover the hydrogen product, and the hydrogen product is essentially a mixture comprising at least 90 vol % H₂ further comprising CH₄. Nitrogen (originating from the feed) may also be present.

Hydrogen product obtained in the hydrogen recovery unit or by methanation can also be used to provide fuel for firing in the reformer. Further, the hydrogen product can be used to provide hydrogen (line 2) to a hydrocarbon feedstock pre-treatment (3), typically hydrodesulphurization. For such recycle, typically 0-5% of the produced hydrogen product is used, in particular 0.5-3%, dependent on the quality of the feed and whether another source of hydrogen is used or not.

In addition to the hydrogen-comprising product, usually at least substantially consisting of hydrogen, a hydrogen recovery step results in a tail gas, which may still contain hydrogen, although typically in a reduced concentration, relative to the process gas prior to having been subjected to hydrogen recovery.

Part of the hydrogen-comprising product obtained in the hydrogen recovery unit is advantageously fed to the radiant section (12) where it is combusted. Accordingly, in a preferred embodiment, a pressure swing adsorption unit or a selective hydrogen membrane separator is used for recovering the hydrogen-comprising gas product and part of said gas product is used as fuel in the radiant section.

Alternatively or in addition to using part of the hydrogen product as fuel, a part of the hydrogen product, preferably obtained by PSA or hydrogen-selective membrane separation is compressed and recycled (2) and combined with the hydrocarbon feed upstream of the reformer, typically upstream of a feed purification making use of hydrogen, such as hydrodesulphurization. The recycle stream is advantageously combined with the hydrocarbon feed in a relative amount to provide at least 0.003 kg H₂ per kg hydrocarbon feed. In practice, the relative amount is usually 0.1 kg H₂ per kg hydrocarbon feed or less, preferably 0.05 kg H₂ per kg hydrocarbon feed or less. When using a different source of hydrogen to supply to the hydrocarbon feed to be pre-treated (such as hydrogen-comprising gas product, obtained in unit 8), a similar relative amount of hydrogen is generally supplied for adequate operation of the purification making use of hydrogen. The skilled person will be able to determine an advantageous maximum relative amount, dependent on the catalyst and the feed, based on common general knowledge, the references cited herein and the present disclosure.

The tail gas from a hydrogen recovery unit may still contain hydrogen gas. It may further contain residual non-converted hydrocarbon from the feedstock, in particular methane, and carbon monoxide formed in the reformer system or shift reaction zone respectively. Accordingly, all or part of the tail gas may be fed from the hydrogen recovery unit (8) via a gas line (10) to the radiant section (12) where the combustible component thereof is combusted to generate heat. Generally, this tail gas is the only source of carbon resulting to CO₂ emissions from the firing, in a process according to the invention.

For a further reduction of CO₂ emissions from the reformer, tail gas from a hydrogen recovery unit may also be compressed, recycled (28) and combined with the hydrocarbon feed upstream of the feed purification (3) or reformer or with reformate before introduction in the shift reactor zone. This is schematically shown in FIG. 4. An embodiment wherein tail gas is recycled and to be subjected to reaction conditions in a reformer unit (5, 22) or the shift reactor zone (7) is in particular preferred for reducing greenhouse gas emissions. When feeding tail gas comprising CO and/or hydrocarbon (in particular methane) to the radiant section for combustion it generates CO₂ that is typically emitted into the atmosphere, whereas the CO₂ generated from the recycled tail gas can be captured in the carbon dioxide recovery unit and stored or be put to further use. The tail gas to be recycled is usually compressed in a compressor (27), since the tail gas pressure is usually considerably lower than the pressure of the stream with which it is to be combined, e.g. more than 10 times lower. E.g. tail gas pressure from a PSA may be about atmospheric or slightly higher, e.g. about 0.3 barg, compared to a feed pressure in the range of about 25 to about 40 barg. The tail gas may also comprise an amount of hydrogen. A separate recycle of hydrogen rich gas, for instance hydrogen product obtained in hydrogen recovery section, which is employed in a process without tail gas recycle, can then be omitted in this embodiment. The hydrogen present in the tail gas is sufficient to supply the required hydrogen concentration for the feed purification section.

A minor part of the tail gas may need to be purged, if inert gas (in particular nitrogen) builds up due to recycling. This is accomplished by feeding a part of the tail gas to burners of the radiant section, where combustible components serve as fuel and the inert gas is purged. Usually less than 10 vol % of the tail gas is needs to be purged (fed to the radiant section, via line 10) in this embodiment. The maximum that is advantageously recycled is generally based on when an unacceptable build-up of gasses occurs. In the absence of such build-up, essentially all of the tail gas is advantageously recycled, as all heat needed for firing the reformer can be provided by the hydrogen product gas obtained in a hydrogen recovery unit (8).

Recycling tail gas is an option in accordance with the invention. It is in particular advantageous effect for further reduction of carbon dioxide emissions/footprint, but will also increase the reformer capacity requirements, since there will be a larger flow of feed (including recycle stream through the reformer reaction units. Thus, in a process according to the invention, the fraction of the tail gas from the hydrogen recovery unit (8) that is recycled can be any fraction from 0-100 vol %; and an optimum can be chosen dependent on making an assessment of the needed/desired CO₂ emission reductions, the needed/desired global CO₂ footprint reduction and what is a desired or acceptable size of the reformer system (or plant as a whole). The benefit of combining recuperative reforming (or parallel reforming) with tail gas recycle with respect to lowering CO₂ emissions becomes bigger with larger recycle flowrate. Thus, for an additional beneficial effect on CO₂ emissions, a tail gas recycle of at least about 10 vol %, preferably at least 25 vol %, more preferably at least 40 vol %, in particular at least 50 vol % can be used. Depending on acceptable requirements of the reformer system, the tail gas recycle can be up to 100 vol %, up to 80 vol %, up to 60%, up to vol %, or up to 20 vol %.

As also indicated above, the downside of additional firing with hydrogen product as such requires more feed and would—without adequate measures as described herein—consequently result in more tail gas recycle again requiring more firing and thus even more feed. However, the present invention allows a significant net hydrocarbon conversion to hydrogen-comprising product (9) that can be taken from the process by further reducing the firing requirement. This is achieved in particular with the recuperative reforming tubes or heat exchange reformer to both minimize the firing duty requirement in the reforming process and by further combining CO₂ removal from process gas (reformate and/or shift reactor product) to maximize the recovery of CO₂ from the process gas resulting in a highly efficient low carbon footprint process respectively hydrogen plant. Additionally and advantageously, the firing is reduced significantly by the internal heat recovery thereby reducing the need for firing part of the hydrogen product and thereby thus further reducing the absolute amount of feed and PSA tail gas recycle further for an equal hydrogen output as compared to technology not using the recuperative reforming or using parallel reformer units in accordance with the invention. The further reduction in purge gas recycle results still further in lower firing requirement. This combined effect results in an unexpected significant reduction in hydrocarbon feed consumption compared to the same process respectively installation without recuperative reforming or parallel reformers respectively. Also a dry reforming process, comprising reducing firing duty in combination with recovery of CO₂ in accordance with the invention also allows for an unexpected reduction in hydrocarbon feed consumption compared to the same process respectively installation without recuperative reforming or parallel reformers respectively.

The recuperative reforming concept allows for higher outlet temperatures and thus lower methane slip, also compared to the parallel reformers concept of the present invention. The lower methane slip and thus also higher CO₂ concentration in the process gas allows for higher carbon removal rate compared to conventional steam reforming technology or conventional dry reforming technology and thereby minimize to the flowrate of the recycled tail gas.

Thus, in a particularly preferred embodiment of the invention, the combination of the reformer design (recuperative and/or the parallel arrangement with a heat exchanger reformer reaction unit), CO₂ removal (20), tail gas recycle (28) from the hydrogen recovery unit (8) and hydrogen product firing (25) of the radiant section (12) of the reformer system allows in a reduction of CO₂ emissions from a reformer plant, in particular from a steam reforming plant, of about 99% or more, in particular while minimizing the hydrocarbon feed consumption (for generation of fuel for the radiant section of the reformer system); at least in certain embodiments, without the requirement of a purge stream from the tail gas a reduction of more than 99.9% is feasible, making it almost a net zero CO₂ emissions plant. In an embodiment wherein tail gas is (to be) recycled from the hydrogen recovery unit and combined with hydrocarbon feed, the mixture of hydrogen carbon feed and further reactant (steam, carbon dioxide or mixture thereof) or reformate, usually no separate hydrogen make up stream, using hydrogen product or another hydrogen rich stream obtained in the process is recycled (passage way 2 is not used/present).

As follows from the above, hydrogen used as fuel in the radiant section or recycled to be combined with the hydrocarbon feed can be part of the hydrogen-comprising product produced in a process according to the invention, advantageously after recovery (8) of the product from a carbon dioxide-depleted product obtained from a carbon dioxide recovery unit (20). It is however also possible to provide an (additional) hydrogen recovery unit at an upstream location in the hydrogen production plant. Advantageously an (additional) hydrogen recovery unit, is configured to recover a hydrogen enriched gas from the reformate, and positioned between the reformate outlet of the reformer system and the feed inlet of the shift reactor zone. This has the additional effect of reducing the reformate's hydrogen concentration, which can help to draw the shift reactor towards the production of hydrogen and thus further reduce the hydrocarbon consumption and maximize the CO₂ capture ultimately resulting in lower CO₂ emissions.

Such effect may also be achieved by positioning a hydrogen recovery unit in between two shift reactor sections of a shift reactor zone comprising two or more shift reactor units.

Another option is to provide an (additional) recovery downstream of the shift reactor zone (7), which may be positioned upstream or downstream of a carbon dioxide recovery unit (20).

If hydrogen enriched gas is used as fuel or recycled, it can generally have a lower hydrogen concentration than is desired for the final hydrogen product Accordingly, less stringent recovery conditions resulting in a lower hydrogen purity can suffice. Particularly suitable is a hydrogen-selective membrane separator. A hydrogen product stream from a methanation unit can also be used for firing in the reformer.

Next, the invention is illustrated by the following Examples.

### EXAMPLES

The table below illustrates the typical data for a hydrogen unit based on SMR technology at a capacity of ˜25,000 Nm3/h. The operating results shown are based on natural gas feed and fuel containing approximately 1.1 vol-% nitrogen. Comparative Case 1A is based on a typical hydrogen plant scheme with a single stage air preheat of approximately 250° C. against flue gas and no CO₂ removal unit. Steam to carbon ratio is 3.0, a high temperature shift reactor with inlet of ˜330° C., a prereformer, a PSA recovery of ˜88% of hydrogen and boiler feed water (BFW) import. This is a typical hydrogen plant flow scheme as per reference FIG. 1, where the product hydrogen has 500 ppmv Nitrogen in the hydrogen product. In Comparative Case 1B, the air preheat is maximized to ˜550 degrees C. and CO₂ is recovered from the process gas.

Reference Case 2 has the same capacity as Case 1A, but high air preheat up to ˜550° C., a low temperature shift reactor with CO₂ removal and 90% PSA recovery. Hydrogen product is applied for firing as indicated in FIG. 4.

Reference Case 4 is the same as Reference Case 2, except that instead of using hydrogen product recycle (line 2) PSA tail gas is compressed and recycled (26, 27, 28) to the feed as indicated in FIG. 4. A purge of 10% of the tail gas is applied to avoid accumulations of nitrogen in the system resulting from the feed natural gas containing approximately 1.1 vol-% nitrogen. An additional benefit is that the PSA tail gas recycle contains sufficient hydrogen for the hydrodesulphurization unit (3) to eliminate the requirement of a separate recycle hydrogen stream.

Case 3 (according to the invention), is exactly the same process configuration as Reference Case 2, except that recuperative reforming is applied. The heat recovered in the reforming tubular reactor is ˜200° C., i.e. the outlet temperature of the reformer tube is ˜200° C. lower than the catalyst outlet temperature.

The same recuperative reforming is applied in Case 5 (according to the invention), which is the same as case 4, but with the use of the recuperative reforming with ˜200° C. heat recovery.

Results are shown in Table 1.

TABLE 1

| | CASE #: | | | | | | |
|---|---|---|---|---|---|---|---|
| | 1A | 1B | 1C | 2 | 3 | 4 | 5 |
| Feed [kg/h] | 5,528 | 5,528 | 5,528 | 6,943 | 6,284 | 7,337 | 6,474 |
| Fuel [kg/h] | 1,899 | 916 | 501 | 700¹⁾ | 439¹⁾ | 1,492¹⁾ | 1,077¹⁾ |
| Total hydro- | 7,427 | 6,444 | 6,029 | 6,943 | 6,284 | 7,337 | 6,474 |
| carbon consumption | | | | | | | |
| [kg/h] | | | | | | | |
| CO₂ emission | 20,148 | 7,008 | 5,880 | 2,572 | 2,322 | 365 | 315 |
| [kg/h] | | | | | | | |
| CO₂ exported | 0 | 10,464 | 10,464 | 16,261 | 14,716 | 19,539 | 17,241 |
| [kg/h] | | | | | | | |
| BFW import | 35,455 | 17,959 | 10,457 | 24,939 | 12,551 | 29,360 | 13,529 |
| [kg/h] | | | | | | | |
| Export steam | 24,720 | 7,332 | 0 | 11,725 | 1,979 | 14,161 | 1,829 |
| [kg/h] | | | | | | | |
| Recycle gas | — | — | — | — | — | 6,324 | 5,580 |
| flowrate [Nm³/h] | | | | | | | |
| Power consumption² | 462 | 1,730 | 1,658 | 2,404 | 2,132 | 4,126 | 3,594 |
| [kWh] | | | | | | | |
| Global CO₂ | 20,333 | 7,700 | 6,543 | 3,534 | 3,175 | 2,016 | 1,753 |
| footprint³⁾ [kg/h] | | | | | | | |
| Reduction of CO₂ | — | 65% | 72% | 87.2% | 88.5% | 98.2% | 98.5% |
| emissions | | | | | | | |
| compared to case 1A | | | | | | | |
| Reduction of | — | 62.1% | 67.8% | 82.6% | 84.4% | 90.1% | 91.4% |
| global CO₂ | | | | | (−10% | | (−13% |
| footprint | | | | | vs. | | vs. |
| compared to case | | | | | case 2) | | case 4) |
| 1A | | | | | | | |
| Reformer size | Base | Base | −15% smaller | +33% larger | +2% larger | +59% larger | +16% larger |
| compared to case | | | | | | | |
| 1A | | | | | | | |

1) Hydrogen product is used for firing.
2) Power consumption including CO₂ compression to 40 barg.
3) Operating global CO₂ footprint including power consumption considering 400 gCO₂/kWh footprint for power.
Case 1A: Comparative case without CO₂ capture
Case 1B: Comparative case with high APH and CO₂ capture
Case 1C: comparative case with high APH, CO₂ capture as Case 1B and additional recuperative reforming
Case 2: Reference case with CO₂ capture and hydrogen firing (no recuperative reforming)
Case 3: Embodiment of the invention with hydrogen firing and recuperative reforming
Case 4: Reference case, as case 2+tail gas recycle (no recuperative reforming)
Case 5: Embodiment of the invention as case 3+tail gas recycle with recuperative reforming

Table 1 clearly indicates that a significant reduction in CO₂ emissions compared to the base case can be achieved, by capturing CO₂ from the process gas and hydrogen product firing can significantly reduce the CO₂ emissions from the hydrogen plant with up to 87%. With only CO₂ capture and the same operating conditions typically a reduction of the CO₂ emission of ˜60-70% is achievable, so hydrogen product firing results in additional reduction of CO₂ emissions at the cost of additional feedstock consumption. This is a big step improvement of the carbon footprint of a hydrogen plant. The increased feedstock consumption as a result additional hydrogen production for firing is more than 25% and consequently a more than 30% larger reformer. At the same time there is also a significant export steam flowrate that in modern refinery complexes is typically available in excess or can be produced elsewhere from renewable sources via an electric boiler or a biomass fed boiler.

A decisive advantage of the invention is achieved by additional recovery inside the reformer by means of recuperative reforming in combination with low pressure drop catalyst (a structured catalyst). The recuperative reforming recovers part of the heat from the reforming reaction directly from the hot reformer effluent and therefore reduces the required firing in the reformer. Case 1B and case 1C clearly indicate that such effect is present where recuperative reforming reduces, the fuel flowrate and subsequently the overall hydrocarbon consumption by ˜7% and CO₂ emissions as well as the reformer size by ˜15%. As in the invention hydrogen product is used for firing, the reduction in firing reduces the required hydrogen produced and subsequently the hydrocarbon consumption is surprisingly reduced further than when just applying recuperative reforming resulting in a reduction by ˜10%. Unexpectedly, the combined effect of the reduced firing and the lower hydrogen consumption for firing reduces the reformer size by 20¬30% (compared to 10-15% for just applying recuperative reforming). Subsequently, the rest of the plant and the CO₂ removal unit is also reduced by 10-15%. This also shown in a reduction in power demand, thereby reducing the global CO₂ footprint even further. The combined effect results in a cost-effective highly efficient low CO₂ footprint hydrogen plant. Table 1 further clearly indicates that with the application of firing of hydrogen product as well as PSA tail gas compression to the feed, the CO₂ emissions can be reduced by more than 98%. This is a significant step increase compared to compared to hydrogen CO2 capture with hydrogen firing only. This is done at the costs of an increase hydrocarbon consumption of more than 30% to supply the hydrogen fired in the reformer. This results in an increase of the reformer of ˜60% compared to the base case, when deep CO2 emission reduction needs to be achieved. At the same time there is also a significant export steam flowrate that in modern refinery complexes is typically available in excess or can be produced elsewhere from renewable sources via an electric boiler or a biomass fed boiler.

A further advantage is the additional recovery inside the reformer by means of recuperative reforming in combination with low pressure drop catalyst in the scheme including PSA purge gas recycle to the feed stream (after compression). Additional to the first example, the decrease in hydrogen required also reduces the amount of PSA tail gas and subsequently the recycle to the feed. This results in a significant reduction in the size of the tail gas compressor as well as in the complete hydrogen plant. The recuperative reforming thus has a combined effect which lowers the recycle as well as the hydrocarbon consumption and consequently significantly reduces the size of the reformer by ˜30 to 40%. This also decreases the size of the balance of the plant by 20-40% the CO2 removal by 10-20%. The reduction of plant size also corresponds to a further reduction in power consumed.

When running the examples with a parallel heat-exchanger reformer in combination with a classical fired reformer (instead of a recuperative reformer), the results with a parallel heat exchanger reformer (not shown above), are very similar to the results shown Table 1. With the exception that there is less steam exported for the same firing, as a higher steam to carbon ratio is required to keep the methane slip low in the heat exchanger reformer which operates at a lower temperature.

The current invention can be optimized on a case to case basis both in new (grassroot) plants as well as in existing plants. The PSA tail gas purge can be optimized based on the nitrogen content in the feed, allowable nitrogen content in the product and the allowable CO₂ emissions. A smaller purge results in higher CO₂ capture rate, a smaller amount of hydrogen product firing and consequently a smaller decrease in reformer size. The purge of the tail gas can be between 0 and 100%.

The operation of the plant can be completely self-sufficient with a minimal requirement of utilities. I.e. An optimization is possible based on zero export steam and all the required steam for the process is produced internally in the plant. The only utilities consumed are hydrocarbon feed, demineralized water or boiler feed water, power and cooling water. Alternatively, the plant could also be designed with import steam for the process, in still another embodiment, where steam for instance is raised with renewable energy and the heat recovery of the SMR is maximized for lowering the fired duty.

### LEGEND TO THE FIGURES

1 hydrocarbon feed supply
2 hydrogen product recycle to feed purification line
3 hydrodesulphurization/feed purification section
4 steam line to reforming section
5 reformer reaction unit
6 waste heat boiler (cools syngas from reformer and produces steam)
7 shift reactor zone
8 hydrogen recovery unit (pressure swing adsorber)
9 hydrogen product gas
10 tail stream passage way from hydrogen recovery unit to radiant/combustion section
11 conventional hydrocarbon make-up fuel supply
12 radiant/combustion section of reformer
13 convection section of reformer
14 steam generator (using heat from 6 and 13)
15 excess export steam
20 CO₂ removal unit
21 CO₂ export stream (high purity)
22 parallel reformer reaction unit
23 steam line to parallel reformer
24 hydrocarbon feed for parallel reformer (+H₂/product gas, PSA tail gas
25 dependent on embodiment) hydrogen make-up fuel for radiant/combustion section 12 of the reformer (part of the product hydrogen from the PS).
26 tail gas line to compressor
27 compressor for tail gas
28 recycle tail gas from hydrogen recovery unit
30 inlet for hydrocarbon-steam feed mixture into reformer reaction zone (catalyst bed)
31. outlet from the catalyst zone into inner channel of the passage way of reformate through the reformer reaction unit
32. part of inner channel of the passage way of reformate through the reformer reaction unit
33. outlet for reformate from the reformer reaction unit.
34. part of inner channel of the passage way of reformate through the reformer reaction unit
35. radiant section
36. reforming catalyst reaction zone (of heat recuperating reformer unit)
37. Mixed hydrocarbon feed with steam (and/or carbon dioxide) to parallel heat exchanger reformer.
38. Outlet for reformate from the reformer reaction unit
39 Mixed outlet from reformer reaction unit and parallel heat exchanger reformer
P=partition (wall) between primary reformer catalyst zone (outer channel) of primary reformer and primary reformate passage way (part) 32 arranged to transfer heat to primary catalyst zone
CZP=Parallel process-gas heated reformer catalyst zone
HEP=Heat transfer passage way for the parallel heat exchanger reformer where the heat of reaction is supplied by the hot reformate outlet (38)

1. A process for producing a hydrogen-comprising product gas from a hydrocarbon, comprising
feeding hydrocarbon feedstock and a further reactant selected from the group consisting of steam, providing water for a reaction with the hydrocarbon, carbon dioxide and mixtures thereof, into a reformer system comprising one or more reformer reaction units (5, 22), at least one radiant section (12) and at least one convection section (13), which radiant section (12) comprises burners that combust fuel thereby providing heat to at least one reformer reaction unit (5) present in the radiant section and a flue gas, which flue gas flows from the radiant section to the convection section (13), where heat is recovered from the flue gas;
subjecting the hydrocarbon in the reformer system to a reaction with the water, carbon dioxide or mixture of water and carbon dioxide under formation of a reformate, comprising hydrogen, carbon monoxide, carbon dioxide and usually water, wherein
the at least one reformer reaction unit (5) present in the radiant section is a heat-recuperating reformer unit, in which heat-recuperating reformer reaction unit (5) the reformate is used as a source of heat—whilst still in the reformer unit—to heat the hydrocarbon, hydrogen and water in the reformer reaction unit (5) upstream of said reformate,
or the reformer system comprises two or more reformer units (5,22) in parallel, wherein at least one parallel reformer unit (5) is present in the radiant section (12) of the reformer system and at least one parallel reformer unit (22) is located outside the radiant section (12) of the reformer system;
subjecting the reformate or a process gas derived from the reformate by a further treatment of the reformate—e.g. a process gas obtained after a further reaction in a shift reactor zone (7) or a tail gas (10) obtained after recovery of hydrogen-comprising product gas (9) in a hydrogen recovery unit (8)—to a carbon dioxide removal treatment (20), thereby obtaining a carbon dioxide depleted process gas, comprising hydrogen;
obtaining the hydrogen-comprising product gas (9) from the carbon dioxide depleted process gas; and
using part of the hydrogen, produced from the reaction of hydrocarbon and water as a fuel in the radiant section (12).

2. Process according to claim 1, wherein the reformer system comprises two or more reformer units (5,22) in parallel, wherein at least one parallel reformer unit (22) located outside the radiant section (12) of the reformer system is a heat-exchanger reformer, wherein heat for the reaction in the parallel reformer unit (22) is supplied by a reformate effluent from the fired reformer unit present in the radiant section (12).

3. Process according to claim 1 or 2, wherein the reformate is fed to a shift reactor zone (7)—typically after having been subjected to cooling in a waste heat boiler (6) wherein steam is produced using heat from the reformate—in which shift reactor zone (7) carbon monoxide reacts with water to form further hydrogen and carbon dioxide, resulting in a shift reactor process gas having an increased hydrogen and carbon dioxide content compared to the reformate.

4. Process according to claim 1, 2 or 3, wherein reformate or shift reactor process gas is subjected—optionally after a further treatment of reformate respectively shift reactor process gas—to a carbon dioxide removal treatment (20), wherein the carbon dioxide content in said reformate respectively shift reactor process gas is reduced and a carbon dioxide-depleted process gas is obtained, and subjecting the carbon dioxide-depleted process gas to a treatment (8) whereby the hydrogen comprising product gas is obtained.

5. Process according to claim 4, wherein the hydrogen-comprising product gas (9) is obtained in a hydrogen recovery unit by recovering it from the carbon-dioxide depleted process gas, in which hydrogen recovery unit further a tail gas is obtained, said hydrogen-comprising gas product (9) having an increased hydrogen content and the tail gas having a reduced hydrogen content compared to the carbon dioxide-depleted product, wherein all the tail gas or a part thereof is used as a fuel in the radiant section (12).

6. Process according to claim 4 or 5, wherein the hydrogen-comprising product gas (9) is obtained in a hydrogen recovery unit by recovering it from the carbon-dioxide depleted process gas, in which hydrogen recovery unit further a tail gas is obtained, said hydrogen-comprising gas product (9) having an increased hydrogen content and the tail gas having a reduced hydrogen content compared to the carbon dioxide-depleted product, wherein all the tail gas or a part thereof is recycled and combined with the hydrocarbon feed, upstream of the reformer system, preferably upstream of a feed pre-treatment unit (3), such as a hydrodesulphurization unit, or combined with reformate upstream of a shift reactor zone; in which process preferably 25-100 wt. %, in particular 50-100 wt. % of the tail gas is recycled.

7. Process according to any of the preceding claims, wherein a pressure swing adsorption unit (8) is used to obtain the hydrogen-comprising product gas (9) from the reformate, from the shift reactor process gas or from the carbon-dioxide depleted process gas, optionally after a further treatment, preferably from the carbon-dioxide depleted process gas, in which unit further a tail gas is obtained, said hydrogen-comprising product gas (9) having an increased hydrogen content and the tail gas having a reduced hydrogen content compared to the reformate, shift reactor process gas or carbon dioxide-depleted process gas from which it has been obtained.

8. Process according to any of the preceding claims, wherein a hydrogen selective membrane separator (8) is used to obtain the hydrogen-comprising product gas (9) from the reformate, from the shift reactor process gas or from the carbon-dioxide depleted process gas, optionally after a further treatment, preferably from the carbon-dioxide depleted product, in which separator further a tail gas is obtained, said hydrogen-comprising product gas (9) having an increased hydrogen content and the tail gas having a reduced hydrogen content compared to the reformate, shift reactor process gas or carbon dioxide-depleted process gas from which it has been obtained.

9. Process according to any of the preceding claims, wherein an electrochemical compressor is used to obtain a hydrogen-comprising product gas (9) from the reformate, from the shift reactor process gas or from the carbon-dioxide depleted process gas, optionally after a further treatment, preferably from the carbon-dioxide depleted product, in which separator further a tail gas is obtained, said hydrogen-comprising product gas (9) having an increased hydrogen content and the tail gas having a reduced hydrogen content compared to the reformate, shift reactor process gas or carbon dioxide-depleted process gas from which it has been obtained.

10. Process according to any of the preceding claims wherein a part of the hydrogen-comprising product gas (9) is used as fuel in the radiant section.

11. Process according to any of the preceding claims, wherein reformate or shift reactor process gas, optionally after a further treatment, is subjected to a carbon dioxide removal treatment (20), wherein the carbon dioxide content is reduced, thereby obtaining a carbon dioxide-depleted process gas, comprising hydrogen and carbon monoxide, and subjecting the carbon dioxide-depleted process gas to a methanation reaction wherein carbon monoxide is converted into methane, thereby obtaining a hydrogen-comprising product gas (9), further comprising methane.

12. Process according to any of the preceding claims, wherein the obtained hydrogen-comprising product gas (9) comprises at least 90 mol % hydrogen, preferably 98-99.99 mol % hydrogen, in particular 99-99.8 mol % mol % hydrogen.

13. Process according to any of the preceding claims, wherein part or all of the hydrogen used as fuel in the radiant section is recovered from a process gas, downstream of the reformer system and upstream from a unit (8) wherein the hydrogen-comprising product gas is obtained—which process gas is preferably selected from the group consisting of reformate and shift reactor process gas—wherein the recovery of said fuel comprising hydrogen is preferably carried out using a hydrogen selective membrane separator, or an electrochemical compressor, or a pressure swing adsorption unit, thereby obtaining from said process gas a fuel gas which is enriched in hydrogen, compared to said process gas, and using thus obtained fuel gas enriched in hydrogen for said fuel in the radiant section.

14. Process according to any of the preceding claims, wherein reformate is subjected to a shift reaction in one shift reactor or two or more shift reactors in series, to obtain a shift reactor process gas, the shift reactor product is subjected to a carbon dioxide removal treatment (20) to obtain the carbon dioxide-depleted process gas and the gas enriched in hydrogen is recovered from the carbon dioxide-depleted process gas using the pressure swing adsorption treatment (8), or an electrochemical compressor (8), or the hydrogen-selective membrane (8), thereby obtaining the hydrogen-comprising product gas (9), of which part is used as fuel in the radiant section of the reformer system.

15. Process according to any of the preceding claims, wherein a further part of the hydrogen formed from the hydrocarbon and water, is recycled (2) to and combined with the hydrocarbon feedstock upstream of a hydrodesulphurization system, wherein the hydrocarbon feedstock is subjected to a hydrodesulphurization treatment.

16. Process according to any of the preceding claims, wherein the reformer system comprises a heat-recuperating reformer unit, preferably comprising an outer reactor channel and an inner heat recovery channel, configured to exchange heat with the outer reactor channel, said heat recovery extending coaxially inside the outer reactor channel, the outer reactor channel containing a catalyst bed catalysing the reaction between the hydrocarbon and the water under formation of reformate, wherein the outer reactor channel has a feed inlet (30) via which the hydrocarbon and the water are fed through the catalyst bed and an outlet (31) for reformate, which inlet and outlet are located at opposite ends of the catalyst bed, wherein the reformate is fed from outlet (31) into the inner channel (32, 34), heat is transferred from the reformate flowing through the inner channel to the contents of the outer reactor channel, and reformate leaves the heat-recuperating reformer unit via a gas outlet (33).

17. Process according to any of the preceding claims, wherein the reformer system comprises a heat-recuperating reformer reaction unit comprising a structured catalyst, preferably an annular structured catalyst.

18. Process according to any of the preceding claims, wherein hydrogen-comprising product gas (9) is obtained in a hydrogen recovery unit (8) in which hydrogen recovery unit reformate, shift reactor process gas or a process gas derived therefrom, comprising carbon dioxide is separated into the hydrogen-comprising product, having an increased hydrogen content compared to respectively the reformate, shift reactor process gas or other process gas derived therefrom before treatment in said hydrogen recovery unit (8) and a tail gas (10) having a reduced hydrogen content compared to respectively the reformate, shift reactor process gas or process gas derived therefrom before treatment in said hydrogen recovery unit (8), and
wherein said tail gas is subjected to a carbon dioxide removal treatment, wherein the carbon dioxide content of the tail gas is reduced.

19. Process according to any of the preceding claims, wherein in the carbon dioxide removal treatment (20) further a gas enriched in carbon dioxide is obtained and part or all of said gas or part or all carbon dioxide recovered from said gas is recycled to one or more of said reformer reaction units (5, 22) to serve as further reactant.

20. Process to any of the preceding claims, wherein the further reactant selected from the group consisting of steam, carbon dioxide and mixtures thereof is steam or contains steam.

21. Process according to any of the preceding claims, wherein the further reactant selected from the group consisting of steam, carbon dioxide and mixtures thereof is carbon dioxide or contains carbon dioxide.

22. A hydrogen plant comprising a reformer system comprising one or more reformer reaction units (5, 22) comprising an inlet for a gaseous mixture, comprising a hydrocarbon and further steam, carbon dioxide or a mixture thereof, and an outlet for gaseous reformate, a radiant section (12) comprising burners configured to provide heat for heating the gaseous mixture in one or more reformer reaction units (5) and a convection section (13), wherein
the reformer system comprises at least one heat-recuperating reformer reaction unit (5) having a reforming reaction zone (36) comprising a catalyst and downstream thereof, yet upstream of an outlet (33) for gaseous reformate, a heat recovery zone comprising a channel adapted for the reformate (32,34) to pass through and transfer heat from the reformate in the passage channel to said reaction zone, which channel is present in the heat-recuperating reformer reaction unit (5),
or which reformer system comprises two or more reformer units (5,22) in parallel, wherein at least one of said parallel reformer units (5) is present in the radiant section (12) of the reformer system, and at least one reformer unit (22) is located outside the radiant section (12) of the reformer system,
the plant further comprising a unit (8) configured to obtain hydrogen product gas, in particular a hydrogen recovery unit or a carbon monoxide methanation unit, downstream of the reformer system and—if present—downstream of the shift reactor zone (7) and having an inlet for process gas originating from the reformer reaction unit (5) or reformer reaction units (5,22) connected to the reformate outlet of the reformer reaction unit (5) respectively reformate outlets of the reformatted reaction units (5,22) via a gas passage way, in which passage way one or more units are optionally present to treat the reformate, preferably at least a shift reactor zone or one or more units to remove one or more unwanted components from the process gas, said unit (8) configured to obtain hydrogen product gas further comprising a gas outlet for the hydrogen product gas, connected to a passage way for withdrawing the product from the plant;
the plant comprises a carbon dioxide capture unit, configured to recover carbon dioxide from a process stream derived from the gaseous mixture comprising hydrocarbon and water, which carbon dioxide capture unit is located downstream of the reformer system and upstream of the unit (8) configured to obtain hydrogen product gas or which carbon dioxide capture unit is located downstream of the unit (8) configured to obtain hydrogen product gas from;
the hydrogen plant further comprising a passage way configured to feed a hydrogen-comprising fuel recovered from a process gas derived from the hydrocarbon feed—which process gas may be the reformate, the process gas produced in the shift reactor zone or which hydrogen-comprising gas stream may be a part of the product gas formed in said hydrogen recovery unit—to burners of the radiant section (12).

23. A hydrogen plant according to claim 22, which unit (8) configured to obtain hydrogen product gas is a hydrogen recovery unit—preferably a pressure swing adsorption unit or a hydrogen selective membrane separator—configured to separate the process gas into hydrogen-comprising product gas (9) having an increased hydrogen content compared to the process gas at the inlet of the hydrogen recovery unit, in particular a product gas at least substantially consisting of hydrogen, and a tail gas (10) having a reduced hydrogen content compared to the process gas at the inlet of the hydrogen recovery unit, the hydrogen recovery unit further comprising an outlet for the product connected to a passage way for withdrawing the product from the plant and an outlet for the tail gas, which tail gas outlet preferably is connected to burner-fuel inlets of burners in the radiant section (12) via a gas passage way (10); and wherein the plant comprises a carbon dioxide capture unit, configured to recover carbon dioxide from a process stream derived from the gaseous mixture comprising hydrocarbon and water, located downstream of the reformer system and upstream of the hydrogen recovery unit (8), or
a carbon dioxide capture unit located downstream of the hydrogen recovery unit (8), adapted to recover carbon dioxide from tail gas (10) from the hydrogen recovery unit (8).

24. A hydrogen plant according to claim 22 or 23, wherein the reformer system comprises a heat-recuperating reformer unit, wherein the reformer reaction zone is located in an outer reactor channel and the heat recovery channel is an inner channel, said heat recovery channel extending coaxially inside the outer reactor channel, wherein the outer reactor channel has a feed inlet (30) for feeding a mixture comprising hydrocarbon and water through the reaction zone comprising the catalyst and an outlet (31) for reformate, which inlet and outlet are located at opposite ends of the reaction zone, wherein a passage way is provided adapted to feed reformate from outlet (31) into the inner heat recovery channel (32, 34), and a reformate outlet (33) from the heat-recuperating reformer unit.

25. A hydrogen plant according to claim 22, 23 or 24, wherein the reformer system comprises a heat-recuperating reformer unit, comprising a reformer reaction zone comprising a structured catalyst, preferably an annular catalyst.

26. Hydrogen plant according to claim 22, 23, 24 or 25, wherein downstream of the outlet for process gas from the shift reactor zone (7) a carbon dioxide recovery unit (20) is provided, having an inlet for process gas from the shift reactor zone (7) connected via a passage way to the outlet for said process gas of said shift reactor zone and configured to remove carbon dioxide from said process gas to obtain a carbon dioxide-depleted process gas, wherein downstream of the carbon dioxide recovery unit (20) the hydrogen recovery unit is provided having an inlet for the carbon dioxide-depleted process gas connected to the outlet for said carbon dioxide depleted process gas via a passage way and which hydrogen recovery unit is configured to separate the carbon dioxide depleted process gas into the product gas having an increased hydrogen content and a tail gas having a reduced hydrogen content,
the hydrogen recovery unit comprising an outlet for product having an increased hydrogen content which outlet is connected to burner fuel inlets of burners in the radiant section via a gas passage way (25)
the hydrogen recovery unit comprising an outlet for tail gas which outlet is connected to a recycle passage way (26, 27,28) adapted to combine tail gas with hydrocarbon feed or a mixture of hydrocarbon and water upstream of the reformer system, preferably upstream of a hydrodesulphurisation system (3) configured to remove sulphur from the hydrocarbon feed.

27. Hydrogen plant according to any of the claims 22-26, wherein the reformer system comprises two or more reformer units (5,22) in parallel, wherein at least one parallel heat-exchanger reformer unit (22) is located outside the radiant section (12) of the reformer system, which heat-exchanger reformer unit is configured to receive reformate effluent from the heat-recuperating reformer unit (5) as a heat exchange medium and configured for transferring heat from the reformate effluent to hydrocarbon feed and further reactant for a reforming reaction inside the heat-exchanger reformer unit.

28. Hydrogen plant according to any of the claims 22-27, the plant further comprising a shift reactor zone (7), configured to subject reformate to a water gas shift reaction, the shift reactor zone having an inlet for reformate connected to the reformate outlet of the reformer system via a gas passage way—e.g. a channel, tube, pipe or line—and an outlet for process gas produced from the reformate in the shift reactor zone.

29. Hydrogen plant according to any of the claims 22-28, adapted to produce a hydrogen-comprising product using a process according to any of the claims 1-21.
